(19) United States
(12) Patent Application Publication
(10) Pub. No.: US 2025/0205931 A1
(43) Pub. Date: Jun. 26, 2025

(54) REDUCING CONTAMINATION IN RECYCLED PLASTICS

(71) Applicant: The Procter & Gamble Company, Cincinnati, OH (US)

(72) Inventors: Norman Scott BROYLES, Hamilton, OH (US); Anthony Frederick Cappel, Cincinnati, OH (US)

(21) Appl. No.: 18/390,098

(22) Filed: Dec. 20, 2023

(51) Int. Cl. B29B 17/02; C08J 11/08

(52) U.S. Cl. CPC B29B 17/02; C08J 11/08; B29B 2017/0289; B29B 2017/0293

(57) ABSTRACT

The present invention generally relates to a method of producing a purer plastic from a first plastic. More specifically, the first plastic is subjected to a purification, wherein the surface contamination present on the first plastic is reduced through mechanical abrasion.

### FIELD OF THE INVENTION

The present invention generally relates to a method of producing a purer plastic from a first plastic. More specifically, the first plastic is subjected to a purification, wherein the surface contamination present on the first plastic is reduced through mechanical abrasion.

### BACKGROUND OF THE INVENTION

Synthetic plastics are ubiquitous in daily life due to their relatively low production costs and good balance of material properties. They are used in a wide variety of applications, such as packaging, automotive components, medical devices, and consumer goods. To meet the high demand of these applications, hundreds of millions of tons of synthetic plastics are produced globally on an annual basis. The overwhelming majority of synthetic plastics are produced from increasingly scarce fossil sources, such as petroleum and natural gas. Additionally, the manufacturing of synthetic plastics from fossil sources causes the emission of greenhouse gases (GHG), primarily CO₂, in the atmosphere.

The ubiquitous use of synthetic plastics has consequently resulted in millions of tons of plastic waste being generated every year. While the majority of plastic waste is landfilled via municipal solid waste programs, a significant portion of plastic waste is found in the environment as litter, which is unsightly and potentially harmful to ecosystems. Also, plastic waste is leaked into the environment, e.g. washed into river systems and ultimately out to sea.

Plastics recycling has emerged as one solution to mitigate the issues associated with the poor management of the end-of-life of plastics. Recovering and re-using plastics diverts waste from landfills and reduces the demand for virgin plastics made from fossil sources, which consequently reduces GHG emissions. In developed regions of the world, such as the United States and the European Union, rates of plastics recycling are increasing due to greater awareness by consumers, businesses, and industrial manufacturing operations, and due to regulatory frameworks. The majority of recycled materials, including plastics (other than films), are mixed into a single stream which is collected and processed by a material recovery facility (MRF). At the MRF, materials are sorted, washed, and packaged (e.g. in bales) for resale. Plastics can be sorted into individual materials, such as single streams of high-density polyethylene (HDPE) and poly(ethylene terephthalate) (PET), or mixed streams of other common plastics (such as polypropylene (PP), low-density polyethylene (LDPE), poly(vinyl chloride) (PVC), polystyrene (PS), polycarbonate (PC), and polyamide (PA)). The single or mixed streams can then be further sorted, washed, and reprocessed at a plastics recovery facility (PRF) into pellets that are suitable for re-use in plastics processing, e.g., extrusion blow molding, profile extrusion, injection molding, and film making.

However, the utilization of these recycled plastics is currently limited due to contamination, which renders the plastics less valuable compared to virgin plastics. A key to increasing the recycle rates and lowering the CO₂ emissions and plastics pollution is to reduce the contamination to a level allowing broader utilization across more end markets, especially those involving demanding applications requiring low contamination.

Films are a special case of recycled plastics and are predominately polyolefin in composition. Films offer unique challenges for recycling that have yet to be resolved. The utilization of film recycled materials is quite limited due to contamination. The contamination of films per unit mass is higher than other forms due to the high surface area to volume ratio which allows greater opportunity for external contamination. Currently, most film-based recycled plastics are down-cycled into markets that are not circular and are of limited size such as plastics lumber.

As the collection of film-based waste grows, the need for end markets beyond plastics lumber is essential. Ideally, film-based waste will eventually discover a second life in film-based applications, thus ensuring ongoing circularity.

While contamination is problematic for all end market applications, demanding applications have even stricter requirements especially on off-colors and certain chemical contaminants. Off-colors are typically the result of residual inks and pigments from the initial consumer application. In addition, off-colors and chemical contaminants may result from the presence or degradation of print binders and protective lacquers used in the initial consumer application.

Mechanical recycling, also known as secondary recycling, is a process for converting recycled plastic waste into a re-usable form for subsequent manufacturing. A more detailed review of mechanical recycling and other plastics recovery processes are described in S. M. Al-Salem, P. et al., Waste Management, 29 (10) (2009), 2625-2643. Mechanical recycling of rigid plastics typically involves purification of some form involving aqueous-based surface washing followed by drying and melt densification. The melt densification step typically includes melt filtration and devolatilization. For film-based materials, there are dry processes and wet washing processes. In the dry process, a controlled film stream is typically shredded, dried, densified, and then melt extruded into the final form. This type of process is very inefficient at removing any form of contamination that is not volatile and migratable. Melt filtration and devolatilization are typically part of the extrusion step. The devolatilization step may aide in the removal of volatile by-products but generally is ineffective at removing overall color, binders, metallization, etc. In the wet washing process, a controlled film stream is typically shredded, washed in a series of steps involving aqueous solution/solutions, rinsed, dried, and then densified and melt extruded into the final form. Melt filtration and devolatilization are typically part of the extrusion step and may aide in the removal of volatiles originating from the surface print and/or binders. This type of process is more efficient at removing surface contamination than the dry process but not to the level needed for heavily contaminated feedstocks including those having extensive surface print, adhesives, labels, cross-linked binders, metallization, protective lacquers, etc. In addition, neither the dry nor wet processes involving aqueous washing significantly remove bulk contamination especially troublesome bulk chemical contamination.

Exemplary examples of commercially available wet purification processes for recycled plastics are wash lines available from Lindner WashTech™. In such processes, the incoming plastic is shredded and then pre-washed with water to remove loosely bound dirt and other surface contamination. The pre-wash is typically conducted using gentle conditions of stirring and/or agitation. Following pre-wash, a more intensive aqueous washing takes place under higher friction/agitation conditions. The aqueous purification fluid may be operated at elevated temperatures and use caustic and other additives to facilitate purification. The downstream process may include rinsing, dewatering, drying, densification, devolatilization, and pelletization.

U.S. Pat. No. 10,022,725 discloses a mechanical recycling method for purifying linear low-density polyethylene (LLDPE)/LDPE film for use in recycling. The patent further discloses the steps of shredding, a first water washing step, a second size reduction step involving wet grinding, a friction washing step or steps where hot water is used in at least one step, a drying or multiple drying steps, and a compaction step. The method is likely to be quite effective at removing some surface contamination that is loosely bound but will be ineffective at removing tightly bound surface contamination and bulk contamination due to extremely low solubility of the bulk contaminants in the aqueous washing media and/or limited diffusivity of the bulk contaminants within the plastic. The method is silent on the state of the inherent plastic microtexture before and after said washing steps. The method is silent on the use of particles to achieve the friction washing. U.S. Pat. No. 9,616,595 discloses a mechanical recycling method for de-inking surface-printed plastic films. The patent further discloses steps of grinding, ink removal steps, general washing, recovery of the cleaning solution, recovering pigments, and drying. The ink removal step involves the use of an aqueous purification fluid with high pH and selective cleaning agents, such as dodecyl sulfate, and high turbulence. The method claims ability to remove surface printed ink. The method is silent on the state of the inherent plastic microtexture before and after said purification steps. The method discloses a chemistry-based approach to ink removal, which will have limited ability to remove prints with binders that are shielded from chemical attack by cross-linking or protective lacquers. In addition, the removal of both surface and bulk contaminants will be very limited due to sparse solubility of certain contaminants in the aqueous washing media. The method is silent on the use of particles to mechanically remove the print and/or binders from the surface of the plastic and silent on the potential modification of surface microtexture.

The above methods are generally acceptable at removing intentional surface contamination such as paper labels, certain loosely bound inks, certain loosely bound adhesives, etc. and unintentional surface contamination such as dirt, grit, sand, etc. but the above methods will have limited ability to remove tightly bound surface contaminants like certain prints with crosslinked binders, metallization, and/or protective lacquers and almost entirely ineffective against bulk chemical contaminants. In addition, the above methods generally do not alter the inherent microtexture of the underlying uncontaminated, unprinted, uncoated, etc., plastic, which may be an indication of low mechanical abrasion on the surface and low potential for purification by physical as opposed to chemical means. The lack of alteration of the inherent surface of the first plastic by these known washing methods is a direct indication of limited ability to remove tightly held surface contamination with or without chemical weakening of the bonding.

The use of particles to remove contamination through mechanical abrasion from various forms of plastics is known. However, these methods do not disclose or envision several of the key attributes of the present invention.

Chinese patent number CN109732457A discloses a method for cleaning colorant (specifically, toner particles) from the interior surface of a mixing device composed of a drum with mixing arms. In this method, abrasive particles are added to the mixing device along with a liquid cleaning solution. As this mixture is mechanically conveyed within the drum by the mixing arms, the abrasive particles remove the colorant from the drum surface and collect inside the cleaning fluid. The cleaning fluid is then dis-charged from the drum leaving a clean drum without colorant on the surface. This method is not related to the removal of surface contamination from recycled plastics or plastics in general and is specific to the removal of pigments particles from the interior of a rotating drum. In addition, the method is silent on altering the physical characteristics of the surface being cleaned (i.e., microtexture on the rotating drum). In addition, the method is silent on separating the colorant removed from the drum surface from the abrasive particles and/or the liquid cleaning fluid for re-use in the process.

US patent U.S. Pat. No. 5,019,161 discloses a method for removing two metal layer coatings from a plastic material. In this method, a first layer of metal is removed by mechanical action wherein a sand scrubber is disclosed. After the first layer of metal is removed, the second metal layer is removed via chemical dissolution processes. The various metals are recovered from both the physical and chemical process steps. This method is silent on the recovery of the plastic and is focused on recovery of the metal/the material being removed from the plastic. In addition, this method is silent on the recovery of the sand-based media used in the sand scrubber including the potential to re-use such in the method. The method is also silent on the modification of the inherent microtexture of the plastic material.

WO201086664 discloses a method for recycling a contaminated article using various steps of heating and pressurization. In the first heating step, the method allows for the inclusion of particles for the abrasion of contamination from the plastic and these may be irregular in shape. Water is preferably used in the step involving plastics with the particles. The particles disclosed in the examples are metal and have overall size much larger than the plastic particles exiting the process, which allows for separation of the plastic through size exclusion wherein the plastic passes through a smaller geometric opening. For instance, the two disclosed examples describe metal particles with diameters between 10 cm and 100 cm. Particles of such a large size relative to the size of typical plastic feedstocks within a recycling process enable the size-based separation disclosed in the method but such would not be effective at removing continuous layers of surface contamination like prints, metallization, lacquers, or small particles on the surface such as grit or sand. Such large particles would have limited sharp contact points with the plastic surface and limited high velocity impact frequency which would minimize effective surface abrasion and impact on microtexture. The method is silent on the modification of the microtexture of the plastic and silent on the unique process requirements to achieve modification of the inherent plastic surface. The method is silent on using density-based differences to separate the particles from the plastic being cleaned and/or the potential re-use of the particles back into the process following potential purification steps. The method is also silent on recovering and potentially purifying the cleaning liquid (water in this method) and re-using in the method. The method is also silent on the utilization of the purification fluid to also extract contamination from the bulk of the plastic via a gradient in chemical potential thus achieving both surface cleaning and bulk extraction in the same method, which is possible with solvent based purification fluids as opposed to the disclosed water-based purification fluids of the method. The method is silent on the specific amount, size, shape, etc. of the particles required to deliver effective surface cleaning and surface texture modification.

Other mechanical-based methods for abrading contamination from the surface of plastics are also known. These methods generally involve mechanical devices that are distinctly different that the particles disclosed in the current invention.

World patent application number WO2014111412A1 discloses a method for surface washing recycled shredded plastics using mechanical friction. The method consists of two coaxial and co-rotating cylinders or conical sections wherein the plastic occupies the annular region. The surfaces of the cylinders and/or conical sections have mechanical ribs to impart the direct cleaning of the plastic by scrapping or rubbing as such passes through the annular region. The spacing in the annular region controls the levels of contact and effectiveness of the friction. If the spacing becomes too low, then mechanical rotation will cease to be possible. If the spacing becomes too high, the insufficient mechanical friction will be achieved, and cleaning compromised or halted entirely. The method is silent on the modification of the inherent microtexture and/or the use of individual particles to remove surface contamination.

Chinese patent CN217916264U discloses a method for cleaning silt from plastics waste wherein a mechanical brush is reciprocated over the plastic. Water is sprayed onto the surface to remove the dislodged silt. While this method likely removes macroscopic surface contamination like silt, it would struggle to remove uniform coatings like print due to the limited contact between individual brush elements and the plastic surface. The method is silent on alterations of the inherent surface texture of the plastic and on the mutual convection of the first plastic with the abrading implement. The method is also silent on the use of particles and other key features of the present invention.

To overcome the fundamental limitations of mechanical recycling based upon aqueous agents as described previously, there have been many solvent-based cleaning fluid methods developed to purify contaminated plastics. Solvent cleaning fluid approaches have the advantage of ability to chemically dissolve or soften the surface contamination and thus render such easier to remove with no or lower mechanical forces of abrasion. In addition, the generally more favorable partitioning of chemical contamination within the solvent relative to the plastic aides in the extraction/leaching of chemical contamination from the bulk of the plastic. Thus, the combination of a solvent-based purification fluid and particles offers the potential for effective surface cleaning while also effectively removing bulk chemical contamination not possible with water-based purification fluid approaches.

U.S. Pat. No. 7,935,736 discloses a method for recycling polyester from plastic waste using a solvent to dissolve the polyester prior to cleaning. This patent also discloses the need to use a precipitant to recover the polyester from the solvent. The method is silent on the use of particles to aide in the surface abrasion to remove surface contamination.

U.S. Pat. No. 11,628,379 B2 discloses methods for cleaning recycled plastics using solvent leaching. Disclosed are methods for both surface washing and bulk extraction using a gradient in chemical potential. Disclosed is the use of solvent based washing to remove surface printed inks. The disclosed methods are silent on the modification of surface texture and/or the ability to use particles to improve removal.

U.S. Pat. No. 5,739,270 discloses a method and apparatus for continuously separating a polymer component of a plastic from contaminants and other components of the plastic using a co-solvent and a working fluid. The co-solvent, at least partially, dissolves the polymer and the second fluid (that is in a liquid, critical, or supercritical state) solubilizes components from the polymer and precipitates some of the dissolved polymer from the co-solvent. The patent further discloses the step of filtering the thermoplastic co-solvent (with or without the working fluid) to remove particles contaminants, such as glass particles. The particles are disclosed as contamination and are not functional or useful in the method.

U.S. Pat. No. 5,368,796 discloses a method for surface cleaning polyethylene films. The patent further discloses the steps of shredding, a first surface washing step (involving a boiling solvent at a temperature below the melting temperature of the polyethylene and at or near ambient pressure, while applying vigorous mechanical agitation for 30 min to rub the ink off), a second surface washing step (involving fresh solvent below the melting temperature of the polyethylene, while applying vigorous mechanical agitation for 30 min), a third surface washing step (involving the solvent below the melting temperature of the polyethylene, while applying vigorous mechanical agitation for 30 to 60 min, and devolatilization), and melt densification. Optionally, the method may include a water washing step prior to treatment with solvent to remove surface dirt. The patent further discloses that the solvent washing accomplishes extraction wherein the solvent does not dissolve the polymer. However, a small amount of wax, typically <1 wt. % may be removed. The solvent washing and extraction steps are further disclosed as occurring at the boiling point of the solvent, which is selected to be below the softening point of the polyethylene to avoid agglomeration. The above method is silent on the specific method used to provide rub-off the ink other than to reference vigorous mechanical agitation. The method is also silent on the modification of the surface texture of the plastic as a result of the mechanical agitation. The method is silent on the use of particles to aide in the mechanical abrading of the surface to remove surface texture. The method is silent on operations for recovering and recycling particles from the liquid cleaning fluid back into the method.

U.S. Patent Application No. 2009/0178693 discloses a method for purifying a plastic. The patent application further discloses a multi-step process involving granulation to form plastic chips, surface washing with supercritical CO₂, surface washing and extraction with a high boiling solvent or mixture of solvents (such as limonene and ethylene lactate), a final surface washing with supercritical CO₂ to remove the high boiling solvent on the surface, and devolatilization. The method is silent on the use of particles to aide in the mechanical abrading of the surface to remove surface texture.

In summary, the known methods to remove surface contamination on recycled plastics, as described above, do not address the issue of removing tightly bound surface contamination such as inks with cross-linked binders, metallization, protective lacquers, etc. In addition, the known methods do not significantly alter the inherent microtexture of the plastics sufficient to enhance surface decontamination. In addition, the methods do not enable the recovery and re-use of the particles and/or cleaning fluid after purification back into the method. Accordingly, there is a need for a method that: 1) produces a purer plastic, i.e., plastic without a significant amount of surface contamination; 2) has the ability to alter inherent plastic microtexture if needed to completely remove surface contamination, 3) is relatively simple in terms of the number of unit operations; 4) is efficient in energy, cost, and overall material utilization; and 5) can be used in high MW plastics, such as those sourced from film and rigid applications.

### SUMMARY OF THE INVENTION

A purification method for producing a purer plastic from a first plastic comprising:
a. obtaining the first plastic, wherein said first plastic has a concentration of surface contaminants;
b. obtaining a purification fluid having particles suspended within the purification fluid;
c. utilizing mutual convection between the first plastic and the purification fluid having suspended particles within to enhance mechanical abrasion of the first plastic;
d. resulting in a purer plastic having a reduced concentration of surface contaminants from the first plastic.

### DETAILED DESCRIPTION OF THE INVENTION

### I. Definitions

As used herein, the term “method” and “process” are used interchangeably.

As used herein, the term “plastic” refers to polymers, such as polyethylene (PE), PP, PET, LLDPE, LDPE, HDPE, polyethylene co-polymers. For the purposes of the present invention, the terms “polymer” and “plastic” are used interchangeably, and the term “MW” refers to the weight-average molecular weight of the polymer.

As used herein, the term “reclaimed plastic” refers to re-grind, pre-consumer, post-consumer, post-industrial, post-commercial, or post-household plastic of various forms including film, fiber, non-woven, and rigid packaging.

As used herein, the term “recycled plastic” refers to reclaimed plastic converted to a form that is used in making products and packaging either in blends with virgin plastic or by itself. The recycled plastic may be purer than the reclaimed plastic or may be identical except in form.

As used herein, the term “first plastic” refers to the plastic which is fed into the purification process and has a level of contamination that includes surface contamination and may include bulk contamination.

As used herein, the term “purer plastic” refers to the plastic which is produced by the purification process from a first plastic. The purer plastic has a level of contamination that is generally lower than that of the first plastic.

As used herein, the term “1st Life plastic” refers to a virgin plastic that has not been utilized in its polymer form for any purpose.

As used herein, the term “contaminant” refers to any undesirable material contained on or within the plastic. The term “chemical contaminant” refers to any undesirable chemical species on the surface of the plastic or within the bulk of the plastic and comprise the molecular or elemental composition of the contaminant. The terms may be used interchangeably depending upon the intent. For example, paper contamination comprise cellulose. Net, cellulose would be one chemical contaminant within the paper contaminant. As used herein, the term “contamination” refers to the sum of all contaminants and the term “chemical contamination” refers to the sum of all chemical contaminants. The chemical contaminants are grouped in classes, which include chemical contaminants that have similar chemical structure. For example, As, Hg, and Cr are chemical contaminants in the “heavy metals” classification. Each contaminant may have different chemical attributes, such as solubility and diffusivity in the plastic, and target levels depending upon concentration and end use market.

As used herein, the term “surface contaminant” refers to a contaminant that is on the surface of the plastic. Similarly, the term “surface chemical contaminant” refers to the molecular or elemental composition of the surface contaminant. The surface contaminant may be attached to the surface of the plastic either loosely through physical attraction forces, or more strongly through polar or other forces. In general, a surface contaminant will have less than about 80% of its surface area embedded in the plastic. Non-limiting examples of surface contamination include paper labels, adhesives used to adhere the labels or other features, printed inks including the binders and associated formulation components such as plasticizers, lacquers, metallization, etc.

As used herein, the term “bulk contaminant” refers to a contaminant that is in the bulk of the plastic. Similarly, the term “bulk chemical contaminant” refers to the molecular or elemental composition of the bulk contaminant. In general, a bulk contaminant will have more than about 80% of its surface area embedded in the plastic.

As used herein, the term “surface contamination” and “surface chemical contamination” refers to the sum of all surface contaminants and all surface chemical contaminants, respectively.

As used herein, the term “bulk contamination” and “bulk chemical contamination” refers to the sum of all bulk contaminants and all bulk chemical contaminants, respectively.

As used herein, the term “total contamination” refers to the sum of the surface contamination and bulk contamination and the sum of all the surface chemical contamination and bulk chemical contamination, respectively.

As used herein, the term “intentional contaminant” refers to a contaminant that is intentionally added by the supply chain for a specific purpose to benefit the producer, retailer, or consumer, but may not be desired in the recycled plastic. As used herein, the term “intentional chemical contaminant” refers to an intentional contaminant described by its chemical composition. As used herein, the term “intentional contamination” refers to the sum of all intentional contaminants and the term “intentional chemical contamination” refers to the intentional contamination described by its chemical composition.

As used herein, the term “unintentional contaminant” refers to any contaminant not intentionally added. Examples include dirt and cross-contamination that is not intentionally added by the producer, retailer, or consumer. As used herein, the term “unintentional chemical contaminant” refers to an unintentional contaminant described by its chemical composition. As used herein, the term “unintentional contamination” refers to the sum of all unintentional contaminants and the term “unintentional chemical contamination” refers to the unintentional contamination described by its chemical composition.

As used herein, the surface area to volume ratio of a plastic is calculated as follows: For generally spherical objects like pellets, ground pellets, micronized pellets, etc., the surface area to volume ratio is calculated by 3/r; where r is the mass average radius. For generally flat and thin objects like film, the surface area to volume ratio is calculated by 2/t; where t is the mass average thickness. For generally long columnar objects like fibers, the surface area to volume ratio is calculated by 2/r; where r is the mass average radius.

As used herein, the term “densified” refers to a state of plastic in which the bulk density of the plastic is higher than the bulk density of the original/pre-densified plastic and the original surface of the plastic is reduced and/or rendered inaccessible to wetting fluids. The process of producing a densified material is referred to as densification.

As used herein, the term “melt densification” refers to densification done near, at, or above the primary melting point of the plastic. Non-limiting methods of melt densification include melt extrusion and agglomeration with equipment, such as the Herbold HV series plastcompactor.

As used herein, the term “primary melting point” refers to the peak melting point (highest endothermic peak on a zero-slope baseline) of the plastic as measured using Differential Scanning calorimetry (DSC). For the purposes of the present invention, the terms “primary melting point”, “melting point”, “melting temperature”, and “primary melting temperature” are used interchangeably. For amorphous materials and/or materials lacking a distinct melting point, the defining temperature will be the approximate softening point of the material, which may be best characterized by the glass transition temperature. Those skilled in the art will understand the appropriateness of the criteria for non-semi-crystalline materials.

As used herein, the term “hexanes” refers to a blend of hexane isomers, such as normal hexane (at least 45 vol %, and typically, about 53 vol %), iso hexane (2-methylpentane, 3-methylpentane, and 2,3-dimethylbutane), and neo hexane (2,2-dimethylbutane).

As used herein, the term “limit of quantification” or “LOQ” refers to the lower detection limit for a given chemical contaminant as determined by the analytical methods. The LOQ is a function of the methods used and may vary from test method to test method.

As used herein, the term “ppm” refers to parts per million, “ppb” refers to parts per billion, and “pptr” refers to parts per trillion.

As used herein, the term abrasion is the process of scraping or wearing material away through mechanical forces.

### II. First Plastic

The first plastic may comprise a virgin plastic or a reclaimed plastic of any form. Also, the first plastic may comprise a first-life plastic (has been used only once before it entered the reclaimed plastic stream), second-life plastic (has been used twice before it entered the reclaimed plastic stream), or higher-life plastic (has been used many times before it entered the reclaimed plastic stream). In an embodiment of the present invention, the first plastic comprises a reclaimed plastic of any form. In another embodiment of the present invention, the first plastic comprises a virgin plastic of any form.

Virgin plastics are predominately free of contamination when first produced at resin suppliers, such as Dow, Nova, ExxonMobil, etc. However, during the plastic's lifecycle contamination is introduced either intentionally or unintentionally. Thus, reclaimed plastics for recycling may contain both intentional and non-intentional contamination.

Non-limiting examples of intentional contamination include surface print, protective lacquers, paper labels, adhesives for labels, metallization, laminates, pigments (such as TiO₂), process additives (such as antioxidant (AO)), etc., that are necessary for marketing, branding, processability, and/or end use performance. Non-limiting examples of unintentional contamination are dirt, cross-contamination, certain heavy metals, pesticides, dioxins, furans, PCBs, etc. Also, unintentional contamination can be produced from reactions involving intentional contaminants, such as the oxidation of paper labels to dioxins, degradation of adhesives or print binders, etc. Most of the latter occurs during thermal treatment methods used during the recycling process. Further oxidation of the plastic during melt processing steps, such as those used for original package or product creation and/or latter recycling, will produce unintentional contamination, such as gels. In addition, unintentional contamination may result from interaction with products. For example, packaging materials that contain cleaning mixtures (e.g., limonene, surfactants, etc.), food (e.g. various organics), etc., will potentially become contaminated with such products. Finally, unintentional contamination can enter the plastic during production, e.g., contamination of a plastic with reaction by-products, unreacted monomers, etc.

Pre-consumer plastic generally has the lowest level of contamination due to its known composition and controlled history. It may include intentional contamination, such as surface print, binders, protective lacquers, paper labels, adhesives, metallization, and opacifiers, but because these are known and controlled, it is quite easy to find applications tolerating such known contaminants assuming such does not degrade or transform into problematic chemical contamination upon reprocessing or exposure to the environment. In addition, pre-consumer plastic tends to have low amounts of unintentional contamination due to the controlled history preventing external contamination.

Post-consumer plastics are generally more contaminated than pre-consumer plastics and generally have the same types of intentional contamination including but not limited to surface print, binders, protective lacquers, paper labels, adhesives, metallization, and opacifiers. The post-commercial subclass of post-consumer plastic has the next lowest level of contamination relative to pre-consumer recycle considering the somewhat controlled life cycle within the commerce supply chain. In general, post-commercial reclaim plastic will have a known and controlled level of intentional contamination, thus enabling broad utilization as reclaimed plastic. However, unintentional contamination is known to be ubiquitous and problematic with this stream, which prevents broad usage in demanding applications.

The post-household subclass of post-consumer has the highest level of contamination considering the uncontrolled life cycle within the commerce channel. Such plastic has high levels of both intentional and unintentional contamination that is highly variable, unknown, and uncontrolled. Such plastics tend to be heavily contaminated especially with surface contamination including but not limited to surface print, binders, protective lacquers, paper labels, adhesives, metallization, and opacifiers. Such plastic may include plastic sources that were originally unacceptable for use in demanding applications. As such, there are limited markets for this plastic source and essentially none in the demanding applications.

Surprisingly, first plastics made purer by the present invention may allow reclaimed plastics from pre-consumer, post-consumer/post-commercial, and post-consumer/post-household plastic to be used more broadly in the demanding applications. In addition, all customers desire purer recycled plastics beyond what is available today and the purer plastics of the present invention potentially meet this need, especially those heavily contaminated with surface print, binders, protective lacquers, paper labels, adhesives, and metallization. In an embodiment of the present invention, the first plastic comprises a regrind/edge-trim/in-plant waste plastic. In another embodiment of the present invention, the first plastic comprises a pre-consumer plastic. In yet another embodiment of the present invention, the first plastic comprises a post-consumer plastic. In an embodiment of the present invention, the first plastic comprises a post-consumer/post-commercial plastic. In embodiment of the present invention, the first plastic comprises a post-consumer/post-household plastic.

For the purposes of the present invention, non-limiting examples of the form of the first plastic include film, sheet, injection molded parts, blow molded parts, fiber, nonwovens, wovens, thermoformed parts, extruded strands, pellets, agglomerates, and powders. In an embodiment of the present invention, the first plastic comprises a film. In an embodiment of the present invention, the first plastic comprises a sheet. In an embodiment of the present invention, the first plastic comprises an injection molded part. In an embodiment of the present invention, the first plastic comprises a blow molded part. In an embodiment of the present invention, the first plastic comprises a fiber. In an embodiment of the present invention, the first plastic comprises a non-woven. In an embodiment of the present invention, the first plastic comprises a woven. In an embodiment of the present invention, the first plastic comprises a thermoformed part. In an embodiment of the present invention, the first plastic comprises a pellet. In an embodiment of the present invention, the first plastic comprises an agglomerate. In an embodiment of the present invention, the first plastic comprises a powder.

The first plastic may comprise combination of forms including but not limited to combinations of films and injection molded parts. The first plastic may comprise laminates of one material form to another. In an embodiment of the present invention, the first plastic comprises a combination of forms. In an embodiment of the present invention, the first plastic comprises a laminate.

In an embodiment of the present invention, the first plastic is comprised of a pre-consumer film. In an embodiment of the present invention, the first plastic is comprised of a post-consumer film. In an embodiment of the present invention, the first plastic is comprised of a non-woven.

The first plastic may be transformed either before, during, or after the purification steps or steps. For example, the first plastic may be reduced in size prior to the purification step or steps. For example, a first plastic in the form of a film may be first shredded prior to the purification step and then densified following the purification step. The first plastic may be transformed by any number of methods including but not limited to shredding, grinding, micronization, cutting, chopping, granulated, densified, etc. In an embodiment of the present invention, the first plastic is reduced in size prior to the purification step. In an embodiment of the present invention, the first plastic is reduced in size to a maximum cross-sectional dimension of 2 cm×2 cm.

Purification is ideally completed on the entirety of the exposed surface of the first plastic to maximize contaminant removal by the purification fluid and associated particles. If the transformation step or steps occur prior to purification, then ideally the transformation method should result in overall size reduction without a loss of original surface. Such methods include shredding, granulation, cutting, tearing, etc. In addition, the transformation method should maintain or improve the exposed surface area and enhance exfoliation to enable better contact of the original surface with the purification fluid and particles.

The transformation method or methods that follow the purification do not benefit from a maintenance of the original surface. Such methods include but are not limited to melt mixing, densification, extrusion, pelletization, etc. In an embodiment of the present invention, the first plastic is reduced in size but not significantly in surface area to volume ratio prior to the purification step. In an embodiment of the present invention, the first plastic is reduced in size but not significantly in surface area to volume ratio prior to the purification step by mechanical shredding. In an embodiment of the present invention, the first plastic is reduced in size by cutting to a mass average cross-sectional area below ˜2 cm×˜2 cm.

The first plastic may be compromised of any natural or synthetic polymer as the base material. Examples include but are not limited to polyolefins, polyolefin co-polymers, polar polyolefin co-polymers, polystyrene, co-polystyrene, polyamides, co-polyamides, polycarbonates, thermoplastic elastomers, styrenic block copolymers, polyesters, co-polyesters, cellulosics, starches, polyalkanoates, PVB, polyvinylalcohols, pvcs, and copolymers of any of the above and mixtures of any of the above. In an embodiment of the present invention, the first plastic comprise polystyrene, co-polystyrene, polyamides, co-polyamides, polycarbonates, thermoplastic elastomers, styrenic block copolymers, polyesters, co-polyesters, polyvinylalcohols, pvcs, and copolymers of any of the above and mixtures of any of the above. In an embodiment of the present invention, the first plastic comprises polyolefins, polyolefin copolymers, and polyolefin polar copolymers. In another embodiment of the present invention, the first plastic comprises LDPE and LLDPE copolymers. In another embodiment of the present invention, the first plastic comprises PP. In yet another embodiment of the present invention, the first plastic comprises HDPE and HDPE copolymers. In embodiment of the present invention, the first plastic comprises PET.

The first plastic may contain non-polymeric components below 75 wt %. Non-limiting examples include mineral fillers such as CaCO3, antioxidants, process aides, colorants, etc.

### III. Surface Contamination and Purification

As discussed previously, contamination may exist on the surface or in the bulk of the first plastic and be intentional or non-intentional. Contamination on the surface is most readily and easily removed by surface cleaning technologies available on the market today and are the primary subject of this invention.

Generic macroscopic descriptions of contamination like print, binder, lacquer, paper, adhesives, metallization, pigment, opacifier, gel, carbon spec, etc. are more appropriate than the specific chemical species like Bisphenol-A, unless trace contaminants are being considered. In an embodiment of the present invention, the surface contamination comprises a surface print. In an embodiment of the present invention, the surface contamination comprises metallization. In general, loosely bound general surface contamination such as dirt or grit may be present at about 0.01 to about 0.1 wt % in the first plastic. However, more contaminated sources including but not limited to post-household may have much higher levels of dirt exceeding the 0.1 wt % limit for the first plastic. In addition, these sources may contain large amounts of surface print, paper labels, adhesives, binders, metallization, and protective lacquers greatly exceeding the 0.1 wt %. Net, post-household sources and any source with heavy surface print, adhesives, binders (especially cross-linked binders), protective lacquers, metalization, etc., will require much more extensive surface cleaning and the processes known today are largely insufficient to remove such contamination.

Surface contamination can be transformed into bulk contamination through melt mixing (extrusion and compounding), melt densification, and other known methods. These methods exchange or eliminate surface area with bulk material. For example, if surface contaminated film such as heavily printed film is melt extruded into a different shape, then all original surface contamination will become bulk contamination, and such will be almost impossible to remove with surface purification methods. Thus, densification, extrusion, pelletization, etc. should be avoided before the surface purification step. It is also common in the recycle industry to shred incoming plastics. The latter methods generally do not convert surface contamination to bulk contamination. Ideally, the method of the present invention should take place on the original contaminated surface of the plastic wherein all original contaminated surface area is reachable by the purification fluid and particles.

In general, surface contamination and bulk contamination are difficult to differentiate using analytical methods. However, the need to differentiate surface from bulk contamination removal is not important in determining the efficacy of a purification method.

A simple method for quantifying a change in surface contamination achieved by abrasion of the contamination is a change in surface texture between the first plastic and purer plastic. This approach assumes abrasion is the primary mechanism for surface texture modification as opposed to competing phenomena such as a change crystalline morphology, migration of additives, embossing, debossing, chemical etching, deposition, etc. One simple means for quantifying a change in microtexture is a change in gloss. A plastic without significant microtexture will generally have high gloss while the same plastic with microtexture will generally have low gloss. Thus, if a purification method produces a plastic with increased haze due to abrasion, the method will generally provide effective surface purification and improved general purification. The purified plastic should be evaluated in a state immediately following the purification with the purification fluid, abraded materials, and particles completely removed and compared to a similar state of the first plastic.

Surface contamination may result in the discoloration of the first and purer plastic. For example, following densification or melt extrusion of the purer plastic, residual surface print will be distributed inside the final densified recycled plastic and result in discoloration compared to the natural coloration of the non-printed base plastic. Other contamination like paper, dirt, etc., will also result in discoloration in the purer plastic and the eventual recycled plastic. Thus, the efficiency of a purification process can be determined by measuring the color change of first plastic compared to the purer plastic. For example, if shredded film is fed to the recycling process as the first plastic and the purification process removes the surface contamination and a purer plastic in shredded form results, then a visual difference in the color of each individual film shred would be indicative of cleaning efficiency. However, it is difficult to quantify such variation due to the heterogeneity of the film shreds. A better comparison is achieved when a sample of the first plastic and a sample of the purer plastic are homogenized and then compared on an average basis. The homogenization is best achieved through densification, melt extrusion, and pelletization of the representative samples. Color differences may be characterized by various means including dE (change in color relative to a “white” standard).

### IV. Mutual Convection Methods

Mutual convection methods are known and involve the convection of a first plastic within a convecting purification fluid. In methods of the current invention, convecting particles are also included in the convecting purification fluid. The convection may be imparted through use of mechanical devices such as arms, baffles, rods, discs, pumps, blowers, vibrators, etc. Non-limiting examples of mutual convection methods include stirred tanks, stirred pipes, rotating drums, fluidized beds, sprayed chambers, vibrating beds, etc. In an embodiment of the present invention, the mutual convection comprises a high-pressure blowing device wherein high pressure and high velocity fluid containing the particles is contacted with the first plastic. In an embodiment of the present invention, the mutual convection comprises a mechanical stirring device inside a stationary tank. In an embodiment of the present invention, the mutual convection method is comprised of a stirred tank or series of stirred tanks. In an embodiment of the present invention, the mutual convection method is comprised of a rotating drum or series of rotating drums. In an embodiment of the present invention, the mutual convection involves a rotating drum. The rate of convection may be controlled by the rotation rate of the mechanical device such as the rate of rotation of the arms, baffles, rods, discs, drums, etc. In an embodiment of the present invention, the mutual convection comprises a mechanical stirring device inside a tank or vessel. In an embodiment of the present invention, the mutual convection comprises a rotating tank or drum. In an embodiment of the present invention, the mutual convection method comprises mechanical stirring at preferably >5 RPM, more preferably >50 RPM, even more preferably >200, and most preferably >400 RPM.

While not wishing to be bound by theory, the ability for the particles to abrade the first plastic is influenced by the state of contact of the plastic and the particles. The state of contact is influenced by the relative velocity field of the first plastic, the particles, and the purification fluid. Ideally, the particles will contact the first plastic at high frequency and high relative velocity at high impact angle (angle closer to normal with plastic) to achieve maximum abrasion potential. In addition, abrasion may also occur due to shearing action between adjacent first plastic layers and particles trapped in-between the layers to increase friction. The latter may also result in size reduction of the first plastic due to tearing, which may be preferred or unwanted depending upon the incoming state of the first plastic. The design of the mutual convection method may be designed to optimize this velocity field to maximize high frequency contact at high velocity and angle while minimizing or maximizing first plastic size reduction. The mechanical energy transferred to the first plastic may be important to abrasion and may be estimated by various means including but not limited to torque on stirring motors, pressure on blowers, etc. The specific energy input to the first plastic may be an important parameter to quantifying the abrasion potential of the mutual convection method.

Mutual convection methods are known in the plastics recycling industry. For example, the aqueous water washing methods discussed previously contain one or multiple steps of mutual convection involving plastic and an aqueous fluid. For example, the plastics washing technologies from Linder (discussed previously), Herbold (Herbold Meckesheim USA, North Smithfield, RI-https://www.herbold.com/en/machines/washing-separating-drying-2/), Sorema (Sorema S.r.l., Anzano del Parco, Italy-http://sorema.it/en_US/applications/washing-line/), and Cadel (Cadel Deinking, Alicante, Spain-http://cadeldeinking.com/en/) involve mutual convection of an aqueous fluid and a first plastic. Broyles et. discloses mutual convection of a solvent and a first plastic using stirred tanks.

The mutual convection may occur in multiple stages involving similar or different convective approaches. For example, two stages of mutual convection may involve two stirred tanks operating in series. For example, one stage of mutual convection may involve a stirred tank and a second stage of mutual convection may involve a rotating drum. In an embodiment of the present invention the mutual convection comprises multiple mutual convection stages. In an embodiment of the present invention the mutual convection comprises two, three, four, and up to ten stirred tanks.

### V. Purification Fluid

Purification fluids are ubiquitous in recycling processes as indicated in the previous section. These are used to mechanically or chemically remove contamination from the first plastic.

The purification fluid may remove both surface and bulk contamination. The purification fluid may also be used as a sink or carrier for the removed contamination. The purification fluid may be purified to remove the contamination at a later stage in the method and re-used back into the method either with additional first plastic or with existing first plastic. The purification fluid may comprise either liquid or gas. In an embodiment of the present invention, the purification fluid is comprised of a liquid. In an embodiment of the present invention, the purification fluid comprises a gas. In an embodiment of the present invention, the purification fluid comprises air. In an embodiment of the invention, the purification fluid comprises nitrogen. In an embodiment of the invention, the purification fluid comprises liquid nitrogen. In an embodiment of the invention, the purification fluid comprises super critical CO2. The purification fluid may comprise a foam wherein a liquid is the major-phase, and a gas is the minor-phase or an equal distribution of phases. The purification fluid may comprise an aerosol wherein the gas is the major-phase, and the liquid is the minor-phase. The purification fluid may comprise water. For example, and discussed previously, known plastics washing processes use a purification fluid comprising an aqueous mixture of surfactants and sometimes caustic. In an embodiment of the present invention, the purification fluid is comprised of water. In an embodiment of the present invention, the purification fluid comprises water and one or more surfactants. In an embodiment of the present invention, the purification fluid comprises water and caustic. In an embodiment of the present invention the purification fluid comprises water, caustic, and one or more surfactants. The purification fluid may comprise an organic solvent. Preferably, the purification fluid may have a boiling point less than about 200° C. for ease of recovery and purification. In an embodiment of the present invention, the purification fluid is comprised of an organic solvent. In an embodiment of the present invention, the purification fluid comprises an organic solvent with a normal boiling point below 200° C.. In an embodiment of the present invention, the purification fluid is comprised of ethyl acetate. In an embodiment of the present invention, the purification fluid is comprised of acetone. In an embodiment of the present invention, the purification fluid is comprised of MEK. In an embodiment of the present invention, the purification fluid is comprised of various alcohols. In an embodiment of the present invention, the purification fluid comprised of various alkanes. In an embodiment of the present invention, the purification fluid comprises various hexanes.

The purification fluid may vary from stage to stage of mutual convection. In an embodiment of the present invention, the purification fluid for mutual convection stage 1 comprises water and the purification fluid for mutual convection stage 2 comprises surfactant and caustic.

The purification fluid may be used to convey the plastic from various purification stages or other stages in the method. The first plastic may be suspended in the purification fluid through appropriate selection of density gradient or through mechanical action of the mutual convective method such as stirring, pumping, spraying, shearing, etc.

The purification fluid may be separated from the plastic during or following the purification of the first plastic. The separation of the purification fluid and plastic may be based upon density differences, size exclusion, volatility differences, etc. The particles may be separated from the plastic following the purification of the first plastic. The separation of the particles may be based upon density difference, size exclusion, volatility differences, etc. The separation of the plastic and particles may occur in the same step or different steps with same or different separation approaches such as density differences, size exclusion, volatility differences, etc. The plastic may leave the separation unit with contaminated residual purification fluid and residual contaminated particles. Further purification steps may be necessary including rinsing the plastic with less contaminated or fresh purification fluid or with less contaminated or fresh water. The resulting contaminated purification fluid may be further purified by many techniques including density, size exclusion, filtration, volatilization, etc. In an embodiment of the present invention, the purification fluid is purified before, during, or after the purification process. The particles may also be contaminated with residual contaminated purification fluid. The particles may be separated and purified by a combination of rinsing, density separation, size exclusion, filtration, volatilization, drying, etc. Any residual contaminated purification fluid may be purified by density difference, size exclusion, distillation/flash/condensation, devolatilization, filtration, adsorption, etc. In an embodiment of the present invention, the purification fluid is separated, purified, and re-used in full or in part back into the purification method. In an embodiment of the present invention, the purification fluid is partially or completely separated from the purified plastic by density differences. In an embodiment of the present invention, the purification fluid is partially or completely separated from the purified plastic by size exclusion. In an embodiment of the present invention, the purification fluid is partially or completely separated from the purified plastic by drying. In an embodiment of the present invention, the purification fluid is partially or completely separated from the particles by density differences. In an embodiment of the present invention, the purification fluid is partially or completely separated from the particles by size exclusion. In an embodiment of the present invention, the purification fluid is partially or completely separated from the particles by drying. In an embodiment of the present invention, the purification fluid is partially or completely purified by size exclusion. In an embodiment of the present invention, the purification fluid is partially or completely purified by flash/distillation/condensation. In an embodiment of the present invention, the purification fluid is partially or completely purified adsorption. The purified purification fluid may be partially or completely re-used in the process or combined with virgin purification fluid to be re-used in the process. In an embodiment of the present invention, the purification fluid is partially or completely re-used in the method. In an embodiment of the present invention, the purification fluid is partially or completely purified re-used in the method after combining with virgin purification fluid. In an embodiment of the present invention, the purification fluid is re-used in the method at >50%. In an embodiment of the present invention, the purification fluid is re-used in the method at >75%. In an embodiment of the present invention, the purification fluid is re-used in the method at >90%.

The temperature of the purification may be operated below the primary melting point of the first plastic if the first plastic is semi-crystalline or below the glass transition temperature if the first plastic is amorphous. The pressure should preferably operate at atmospheric pressure but can be operated in a pressurized state or a state of vacuum. In an embodiment of the present invention, the temperature of the purification is less than the primary melting point for semi-crystalline plastics or the glass transition temperature for amorphous plastics. In an embodiment of the present invention, the temperature of the purification is less than 100° C.

Purification fluids of the present invention may carry the particles and deliver them into contact with the first plastic under mutually convective motion. The purification fluid may also carry the first plastic and particles from the various stages in the process such as further contamination removal via extraction/leaching, separation process, drying, filtration, etc.

### V. Particles

The particles of the present invention are used to mechanically abrade the surface of the first plastic sufficient to remove the surface contamination. The resulting abrasion may be sufficient to alter the incoming microtexture of the base plastic. The surface contamination that is removed due to the abrasion may become suspended in the purification fluid thus producing a contaminated purification fluid or such may be loosely adhered to the plastic surface.

The particles may comprise polymers, metals, ceramics, inorganics, organometallics, etc. Examples of polymers include but are not limited to nylon, polystyrene, ABSs, polyolefins, polyesters, polycarbonates, polyacetals, etc, with or without crosslinking with or without fillers. Non-limiting examples of metals include carbon steel, chrome steel, stainless steel, forged steel, and high chrome steel. Non-limiting examples of ceramics include alumina, burundum alumina, ceramic steatite, glass, silicon carbide, silicon nitride, zirconium oxide, zirconium silicate, tungsten carbide, etc. Non-limiting examples of inorganics include calcium carbonate, talc, titanium dioxide, montmorillonite, etc. The particles may compromise blends of polymers, metals, ceramics, inorganics, organometallics, etc. In an embodiment of the present invention, the particles comprise a polymer. In an embodiment of the present invention, the particles comprise a metal. In an embodiment of the present invention, the particles comprise stainless-steel. In an embodiment of the present invention, the particles comprise a ceramic. In an embodiment of the present invention, the particles comprise a blend of polyethylene and an inorganic. In an embodiment of the present invention, the particles comprise polymers.

The hardness and durability of the particles is important. The hardness may be determined by various hardness measured such as Mohs and Rockwell hardness. The Rockwell C hardness for steel-based particles is preferably >˜50, more preferably >˜55, even more preferably >˜60, and most preferably >˜64. The Rockwell C hardness for non-steel-based metal particles is preferably >˜30. In an embodiment of the present invention, the particles comprise a stainless-steel with a Rockwell C hardness>˜50. In an embodiment of the present invention, the particles comprise a stainless-steel with a Rockwell C hardness>˜55. In an embodiment of the present invention, the particles comprise a stainless-steel with a Rockwell C hardness>˜60. In an embodiment of the present invention, the particles comprise a stainless-steel with a Rockwell C hardness>˜64. The Mohs hardness for ceramic based materials is preferably >˜8.0, more preferably >˜8.5, and most preferably >˜ 9.0. In an embodiment of the present invention, the particles comprise a ceramic with Mohs hardness preferably >˜8.0, more preferably >˜8.5, and most preferably >˜9.0. In an embodiment of the present invention, the particles comprise a ceramic with a Mohs hardness>˜8.0. In an embodiment of the present invention, the particles comprise a ceramic with a Mohs hardness>˜8.5. In an embodiment of the present invention, the particles comprise a ceramic with a Mohs hardness>˜9.0.

The durability of the particles is a function of many constitutive properties and is difficult to quantify. However, certain materials and material class are known to be more durable than others. If the particles degrade over time to produce fines, then such could become contamination for the purer plastic and partially defeat the purpose of the invention. In most cases, the fines should be separable from the purification fluid and the plastic. In the case of particles comprised predominately of materials compatible with the first plastic and the associated end markets, the concern associated with contamination from fines will be minimized. The particles may be comprised of the based material used in the first plastic. For example, if the first plastic is a polyethylene film, then polyethylene-based particles provide potential benefits. In addition, heavily loading the plastic particles with inorganic particles such as CaCO3, talc, or TiO2 may also provide benefits since CaCO3, talc, TiO2 with polyethylene fines would not be problematic in a polyethylene recycled stream. For example, if the first plastic is polyethylene film, then particles involving a masterbatch of TiO2 in polyethylene may be beneficial. In an embodiment of the present invention, the particles comprise a form of the first plastic base material. In an embodiment of the present invention, the particles comprise the base plastic used in the first plastic blended with an inorganic filler such as CaCO3, TiO2, or Talc.

In an embodiment of the present invention, the particles are re-used in the process at >50%. In an embodiment of the present invention, the particles are re-used in the process at >75%. In an embodiment of the present invention, the particles are re-used in the process at >90%. In an embodiment of the present invention, the particles are re-used in the process at >99%.

In an embodiment of the present invention, the particles are separated from the purification fluid and purer plastic and re-used in the process at >50%. In an embodiment of the present invention, the particles are separated from the purification fluid and purer plastic and re-used in the process at >75%. In an embodiment of the present invention, the particles are separated from the purification fluid and purer plastic and re-used in the process at >90%. In an embodiment of the present invention, the particles are separated from the purification fluid and purer plastic and re-used in the process at >99%.

In an embodiment of the present invention, the particles and purification fluid are re-used in the method at >50%. In an embodiment of the present invention, the particles and purification fluid are re-used in the method at >75%. In an embodiment of the present invention, the particles and purification fluid are re-used in the method at >90%. In an embodiment of the present invention, the particles and purification fluid are re-used in the method at >99%.

The particles may be polymeric and different than the base first plastic. In an embodiment of the present invention, the particles comprise polymer. Preferably, the polymer particles have higher hardness than the first plastic. In an embodiment of the present invention, the polymer particles have a Moh's hardness>than the Moh's hardness of the first plastic. In an embodiment of the present invention, the particles are comprised of PET. In an embodiment of the present invention, the particles are comprised of PVOH. In an embodiment of the present invention, the particles are comprised of EVOH. In an embodiment of the present invention, the particles are comprised of ABS. In an embodiment of the present invention, the particles are comprised of polystyrene. In an embodiment of the present invention, the particles are comprised of polycarbonate. In an embodiment of the present invention, the particles are comprised of polyamide/nylon.

The particles may be obtained from a reclaimed or recycled material thus adding to the environmental advantages of the method. For example, recycled glass may be crushed to form particle size and distribution required for acceptable use in the method. In addition, reclaimed glass that is not the correct size for use as an abrasive in the current invention may be processed in-situ with the first plastic to achieve the dual purpose of size reduction of the particles and surface abrasion of the plastic. For example, reclaimed glass of large size may be fed into the method with the first plastic. After processing via the method, the glass may be crushed to a size amenable for surface abrasion thus resulting in efficient purification of the first plastic. The crushed glass may be re-used in the process or sold as a higher value product due to the more preferred size. Thus, the method may be used to both increase the recycling value of a first plastic and increase the value of a recycled glass feedstock. In an embodiment of the present invention, the particles comprise a recycled material. In an embodiment of the present invention, the particles comprise a reclaimed/non-virgin material.

The geometric size of the particles is important in determining the impact frequency and momentum, which will influence abrasion. If the size is large relative to the first plastic, then the particles will have low contact frequency and low abrasion potential. Such a situation may be more favorable to size reduction. However, if the size is too small relative to the first plastic, then momentum of impact and associated abrasion may be compromised. In addition, small particles will be difficult to separate, purify, and re-use in the method. The mass average equivalent sphere diameter of the particles is preferably smaller than the maximal dimension of the first plastic, more preferably less than about 25 mm, even more preferably less than about 10 mm, and most preferably less than about 5 mm. The mass average equivalent sphere diameter of the particles is preferably greater than about 200 microns, more preferably >˜ 500 microns, and most preferably >˜ 1 mm. The equivalent sphere diameter of the particles may vary across a distribution. The distribution may be optimized to give the right balance of abrasion, durability, recoverability, and reusability. In an embodiment of the present invention, the particles have a mass average equivalent sphere diameter below 25 mm but above 200 microns. In an embodiment of the present invention, the particles have a mass average equivalent sphere diameter below 10 mm but above 500 microns. In an embodiment of the present invention, the particles have a mass average equivalent sphere diameter below 5 mm but above 0.7 microns. In an embodiment of the present invention, the number distribution of the equivalent sphere diameter of the particles is bimodal.

The geometrical shape of the particles determines the number and frequency of contact points with the first plastic which controls the ultimate abrasion and surface purification potential. The geometrical shape of the particles also may influence the durability and re-usability of the particles, which is important to overall economics and environmental sustainabilty. The geometrical shape of the particles may be but not limited to sphere/round, satellite, balcone, cylinder, diagonal, conical, whisker/needle, etc. The geometrical shape of the particles may vary and have a specific distribution of various shapes to influence the balance of surface abrasion, durability, and separability. In an embodiment of the present invention, the particles comprise a sphere/round shape. In an embodiment of the present invention, the particles comprise a satellite shape. In an embodiment of the present invention, the particles comprise a balcone shape. In an embodiment of the present invention, the particles comprise a cylinder shape. In an embodiment of the present invention, the particles comprise a combination of different shapes.

A density difference between the particles and the purification fluid aides in density-based separation to allow re-use of the particles and the purification fluid. In addition, high density of particles improves abrasion due to increased impact momentum. However, too high density may increase cost for a given loading ratio and may wear equipment excessively. The density of the particles should preferably be at least 10%, more preferably at least 25%, even more preferably at least 50%, and most preferably 100% greater than the density of the purification fluid. In an embodiment of the present invention, the density of the particles is at least 10% greater than the density of the purification fluid. In an embodiment of the present invention, the density of the particles is at least 25% greater than the density of the purification fluid. In an embodiment of the present invention, the density of the particles is at least 50% greater than the density of the purification fluid. In an embodiment of the present invention, the density of the particles is at least 100% greater than the density of the purification fluid. The particles may be a blend of different density particles.

The volume ratio of the particles relative to the first plastic relative to the purification fluid is important to abrasion. If the volume of the particles is too high relative to the other components, then excessive energy would be required to convey the mixture and size reduction may be favored over abrasion. If the volume of the particles is too low, then contact frequency will be reduced and abrasion compromised. If the volume of the particles is too high relative to the volume of the purification fluid, then size reduction of the first plastic may be favored over abrasion. The volume ratio of the particles to the purification fluid is preferably between about 0.01 and 10.0, more preferably between about 0.02 and 5.0, even more preferably between about 0.04 and 2.0, and most preferably between about 0.1 and 1.0. In an embodiment of the present invention, the volume ratio of the particles to the purification fluid is at least 0.01 but less than about 10.0. In an embodiment of the present invention, the volume ratio of the particles to the purification fluid is at least 0.02 but less than about 5.0. In an embodiment of the present invention, the volume ratio of the particles to the purification fluid is at least 0.04 but less than about 2.0. In an embodiment of the present invention, the volume ratio of the particles to the purification fluid is at least 0.1 but less than about 1.0.

The volume ratio of the particles to the first plastic is preferably between about 0.01 and 100.0, more preferably between about 0.05 and 50.0, even more preferably between about 0.1 and 10.0, and most preferably between about 0.5 and 5.0. In an embodiment of the present invention, the volume ratio of the particles to the first plastic is at least 0.01 but less than about 100.0. In an embodiment of the present invention, the volume ratio of the particles to the first plastic is at least 0.05 but less than about 50.0. In an embodiment of the present invention, the volume ratio of the particles to the first plastic is at least 0.1 but less than about 10.0. In an embodiment of the present invention, the volume ratio of the particles to the first plastic is at least 0.5 but less than about 5.0.

### VII. Purer Plastic

The purer plastic produced by the method may have a lower level of contamination relative to the first plastic. As discussed previously, a decrease in gloss may be indicative of improved contamination removal and improved purification efficiency. For the gloss to be relevant, the purified plastic should be evaluated in a state immediately following the purification with the purification fluid, abraded materials, and particles completely removed and compared to a similar state of the first plastic. The purer plastic has a gloss value preferably 25%, more preferably 50%, and most preferably 70% lower than that of the first plastic. In an embodiment of the present invention, the purification results in a reduction in gloss between the first plastic and purer plastic of at least 25%. In an embodiment of the present invention, the purification results in a reduction in gloss between the first plastic and purer plastic of at least 50%. In an embodiment of the present invention, the purification results in a reduction in gloss between the first plastic and purer plastic of at least 70%.

In addition to changes in gloss, the efficiency of the purification method may be determined by measuring the color change of the first plastic compared to the purer plastic assuming the first plastic has undesirable color due to contamination. Color differences may be characterized by various means including dE relative to a “white” standard or other color standard. For example, if the target end market for the purer plastic is white material, then a white standard may be used. For example, if the target end market for the purer plastic is clear material, then a clear standard may be used. The dE of the homogenized purer plastic is preferably at least 10%, more preferably at least 20%, even more preferably at least 40%, and most preferably at least 75% lower than the dE of the homogenized first plastic against the same standard. In an embodiment of the present invention, the purification results in an improvement in dE between the homogenized first and homogenized purer plastic of at least 10% relative to the same standard. In an embodiment of the present invention, the purification results in an improvement in dE between the homogenized first and homogenized purer plastic of at least 20% relative to the same standard. In an embodiment of the present invention, the purification results in an improvement in dE between the homogenized first and homogenized purer plastic of at least 40% relative to the same standard. In an embodiment of the present invention, the purification results in an improvement in dE between the homogenized first and homogenized purer plastic of at least 70% relative to the same standard.

The purer plastic from the purification step may be further processed to produce a pellet or other end use material. If a pellet is desired, then such step could involve melt extrusion followed by pelletization. The melt extrusion may optionally include a melt filtration step and/or a devolatilization step. The melt extrusion may add additional ingredients to the purer plastic, such as AO, slip agents, anti-block agents, TiO₂, colorants, etc. In an embodiment of the present invention, the pure plastic is converted into a different form than the first plastic.

The purer plastic may contain small amounts of the solvent in either physically adsorbed or bulk absorbed form. The concentration of the solvent in the purer plastic may be reduced by devolatilization techniques. In an embodiment of the present invention, said purer plastic is devolatilized to a content of <1 wt % solvent in the first plastic.

### VIII. EXAMPLES

### Comparative Example 1a—Surface Contaminant Removal of Surface Printed Film #1 Using Traditional Methods of Water Washing involving Low pH, Surfactants, and Mechanical Agitation

A first plastic material, consisting of Surface Printed Film #1, was fed into a “simulated” water wash process of known art. The “simulated” water wash process follows the guidance of the APR Guidance on Caustic Wash of Polyolefins with modifications due to equipment limitations and to provide best-case removal performance. The first plastic was an opacified white base polyethylene film with extensive surface print and a protective varnish. The base film used in the first plastic was glossy and without significant microtexture as represented by its high gloss of 66.5% at 60° (Table 1). The dE of a compounded and melt pressed sample was 24.8 relative to a white standard sample. The first plastic was cut into ˜1.5 cm×˜1.5 cm pieces.

To produce the cleaning fluid, 250 grams of DI water was added to a 2L baffled round bottom flask along with 0.6 grams of Triton X-100 surfactant and 2.5 grams of sodium hydroxide. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding ˜50 grams of the cut first plastic to the aqueous liquid in the stirring vessel and allowed to continue for 20 minutes. After the 20 minutes, the stirring and heating were stopped and the first plastic/liquid mixture was allowed to sit for ˜1 minute. After the 1 minute, the plastic/liquid mixture was poured through a filter funnel to decant the liquid from the wet plastic. The wet plastic was then re-introduced to the 2L baffled round bottom and ˜500 grams of DI water was added to the round bottom and mixing was re-started at ˜400 RPM for ˜1 minute. The stirring was stopped and the mixture was allowed to sit for ˜1 minute. After ˜1 minute, the wet plastic/liquid mixture was poured through a filter funnel to decant most of the liquid from the plastic to produce a wet plastic. The wet plastic was then placed into a 2L graduated cylinder and 1.5L of DI water was added. The wet plastic was rapidly stirred with a long rod for 30 seconds at ˜300 RPM. After stirring, the wet plastic was then floated to the top of the water by density gradient for ˜1 min and poured back into the filter funnel. The wet plastic within the filter funnel was removed, manually squeezed by hand, and placed on a stainless-steel sheet to dry overnight to produce the purer plastic.

The appearance of the purer plastic was similar in gloss compared to the first plastic. In addition, the print was largely intact and was not removed by the simulated traditional water washing method. The gloss value of the purer plastic was 56.7% compared to 66.5% at 60° for the first plastic (Table 1) for a reduction in gloss of about 15%, which suggests the simulated water washing process does not significantly abrade the surface and/or modify the inherent microtexture of the base plastic. The dE of a compounded and melt pressed version of the purer plastic was 20.7 relative to a white standard sample. The % change improvement in dE for the first plastic compared to the purer plastic was about 17%, which is indicative of slight color improvement after the simulated water washing process of known art. The purer plastic was still strong brown in coloration compared to the first plastic. Net, the simulated method for traditional water washing known in the art for recycled plastics did not significantly alter the surface texture and/or significantly abrade the surface. In addition, the traditional water washing method including caustic struggled to remove tightly bound contamination including surface printed inks and protected by lacquers.

COMPARATIVE EXAMPLE 1b-Surface Contaminant Removal of Surface Printed Film #1 Using Traditional Methods of Water Washing involving Surfactants and Mechanical Agitation. A first plastic material, consisting of Surface Printed Film #1, was fed into a “simulated” water wash process of known art. The “simulated” water wash process follows the guidance of the APR Guidance on Non-Caustic Wash of Polyolefins with modifications due to equipment limitations and to provide best-case removal performance. The first plastic was an opacified white base polyethylene film with extensive surface print and a protective varnish. The base film used in the first plastic was glossy and without significant microtexture as represented by its high gloss of 66.5% at 60° (Table 1). The dE of a compounded and melt pressed sample was 24.8 relative to a white standard sample. The first plastic was cut into ˜1.5 cm×˜1.5 cm pieces.

To produce the cleaning fluid, 250 grams of DI water was added to a 2L baffled round bottom flask along with 0.6 grams of Triton X-100 surfactant. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding ˜50 grams of the cut first plastic to the aqueous liquid in the stirring vessel and allowed to continue for 20 minutes. After the 20 minutes, the stirring and heating were stopped and the first plastic/liquid mixture was allowed to sit for ˜1 minute. After the 1 minute, the plastic/liquid mixture was poured through a filter funnel to decant the liquid from the wet plastic. The wet plastic was then re-introduced to the 2L baffled round bottom and ˜500 grams of DI water was added to the round bottom and mixing was re-started at ˜400 RPM for ˜1 minute. The stirring was stopped and the mixture was allowed to sit for ˜1 minute. After ˜1 minute, the wet plastic/liquid mixture was poured through a filter funnel to decant most of the liquid from the plastic to produce a wet plastic. The wet plastic was then placed into a 2L graduated cylinder and 1.5L of DI water was added. The wet plastic was rapidly stirred with a long rod for 30 seconds at ˜300 RPM. After stirring, the wet plastic was then floated to the top of the water by density gradient for ˜1 min and poured back into the filter funnel. The wet plastic within the filter funnel was removed, manually squeezed by hand, and placed on a stainless-steel sheet to dry overnight to produce the purer plastic.

The appearance of the purer plastic was similar in gloss compared to the first plastic. In addition, the print was intact and showed no signs of even partial removal. The lack of caustic and the lack of significant surface abrasion left the tightly held print intact. The gloss value of the purer plastic was slightly lower than the first plastic (40.9% compared to 66.5% at 60° for the first plastic (Table 1)), which was an indication of low surface abrasion. The dE of a compounded and melt pressed version of the purer plastic was 24.1 relative to a white standard sample, which was statistically identical to the dE of the first plastic (24.8). Net, the simulated water washing process without caustic only slightly abraded the surface and did not significantly remove tightly held surface print.

COMPARATIVE EXAMPLE 2-Surface Contaminant Removal of Surface Printed Film #2 Using Traditional Methods of Water Washing involving Low pH, Surfactants, and Mechanical Agitation.

A first plastic material, consisting of Surface Printed Film #2, was fed into a “simulated” water wash process. The “simulated” water wash process followed the guidance of the APR Guidance on Caustic Wash of Polyolefins with modifications due to equipment limitations and to provide best-case removal performance. The first plastic was an opacified white base polyethylene film with extensive surface print. The base film used in the first plastic was glossy and without significant microtexture as represented by its high gloss of 30.7 (Table 1). The dE of a compounded and melt pressed version was 18.2 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel and allowed to continue for 20 minutes. After the 20 minutes, the stirring and heating were stopped and the first plastic/liquid mixture was allowed to sit for ˜ 1 minute. After the 1 minute, the plastic/liquid mixture was poured through a filter funnel to decant the liquid from the wet plastic. The wet plastic was then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/liquid mixture was poured through a filter funnel to decant most of the liquid from the plastic to produce a wet plastic. The wet plastic was then placed into a 2L graduated cylinder and 1.5L of water was added. The wet plastic was rapidly stirred with a long rod for 30 seconds at ˜300 RPM. After stirring, the wet plastic was then floated to the top of the water by density gradient over the course of ˜1 minute and poured back into the filter funnel. The wet plastic within the filter funnel was removed, manually squeezed by hand, and placed on a stainless-steel sheet to dry overnight to produce the purer plastic.

The appearance of the purer plastic was similar in gloss compared to the first plastic. In addition, a large portion of the ink was removed for this particular ink/binder system, which was contrary to Comparative Example #1a with Film #1 using a similar process. The gloss value of the first plastic was 30.7% compared to 25.6% for the purer plastic (Table 1) for a total reduction in gloss of about 17%, which suggests this simulated water washing process did not significantly abrade the surface and/or modify the inherent microtexture of the base plastic despite somewhat effective print removal for this specific print/binder system. The dE of a compounded and melt pressed version of the purer plastic was 18.2 relative to a white standard sample, which matched the first plastic's dE of 18.2. Net, the simulated traditional water washing did not significantly improve the overall coloration of the homogenized sample despite the visual film appearance. Thus, the simulated water washing process of the known art was not entirely effective for this particular print and binder system at removing noticeable color in the homogenized purer plastic.

### Comparative Example 3-Surface Contaminant Removal of Printed Film #1 Using Known Methods of Solvent Washing Involving Mechanical Agitation

A first plastic material, consisting of Surface Printed Film #1, was fed into a solvent wash process. The first plastic was an opacified white base polyethylene film with extensive surface print and a protective lacquer. The base film used in the first plastic was glossy and without significant microtexture as represented by its high gloss of 66.5% (Table 1). The dE of a compounded and melt pressed version was 24.8 relative to a white standard sample. The first plastic was cut into ˜1.5 cm×˜1.5 cm pieces.

The cleaning fluid was prepared by adding 500 grams of ethyl acetate to a 2L baffled round bottom flask. The flask was outfitted with a mechanical paddle stirrer, one reflux condenser, and one heat jacket. The mechanical stirring was set to 400 rpm to achieve rapid convection. The heating jacket was controlled by a variable voltage transformer. The heat was applied to rapidly bring the temperature of the liquid to the boiling point of ethyl acetate (˜77° C.). Once boiling was reached, the heat was adjusted to achieve a reflux rate of approximately 1 gram per second. The solvent washing was initiated by adding 50 grams of the cut first plastic to the liquid in the stirring vessel and allowed to continue for 25 minutes. After the 25 minutes, the ethyl acetate was decanted from the flask and 250 grams of fresh ethyl acetate at room temperature was added to the flask. Stirring was briefly re-initiated at ˜400 RPM for ˜1 minutes. After the brief stirring, the ethyl acetate was decanted from the flask and another 250 grams of fresh ethyl acetate at room temperature was added to the flask. Stirring was again briefly re-initiated at ˜400 RPM for ˜1 minutes. After the brief stirring, the ethyl acetate was decanted from the flask. The wet plastic was removed and placed into a 2L graduated cylinder. 1.5L of water was added to the graduated cylinder and then rapidly stirred with a stainless-steel rod at ˜300 RPM for ˜1 minute. After stirring, the wet plastic was floated to the top over the course of ˜1 minute and then poured into a filter funnel to isolate the wet plastic from the water. The resulting plastic was placed on a stainless-steel pan and allowed to dry overnight to produce the purer plastic.

The appearance of the purer plastic was similar in gloss compared to the first plastic. In addition, most of the dark colored inks were removed but residual pinks and blues were evident.

The gloss value of the first plastic was 66.5% compared to 51.5% for the purer plastic (Table 1), which indicates slight surface texture modification and mild surface abrasion due to the solvent washing process. The dE of a compounded and melt pressed version of the purer plastic was 10.0 relative to a white standard sample. The % improvement in dE for the first plastic compared to the purer plastic was 60%, which was indicative of significant color improvement relative to water-based washing methods of Comparative Example 1a and Comparative Example 1b. However, the dE was still higher than that of the white standard, which means further improvement was still needed. Net, a known solvent-based method for purification did not significantly alter the surface texture and did not remove all discoloration caused by residual surface print.

### Example 1a (i)-Surface Contaminant Removal of Surface Printed Film #1 Using Traditional Methods of Water Washing Involving Low pH, Surfactants, Mechanical Agitation, and Crushed Glass Particles of the Current Invention (121)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant and 2.5 grams of sodium hydroxide. In addition, particles represented by 250 grams of crushed glass (Aldrich Silicone Dioxide 4-20 mesh/1 to 5 mm average diameter) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 1.8 to 1.0 to 4.7 for particles to first plastic to purification fluid) and allowed to continue for 20 minutes. After the 20 minutes, the stirring and heating were stopped and the first plastic/liquid mixture with particles was allowed to sit for ˜1 minute. After the 1 minute, the plastic/liquid mixture with particles was poured through a filter funnel to decant the liquid from the wet plastic and wet particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/cleaning fluid mixture with particles was poured through a filter funnel to decant most of the cleaning fluid from the plastic and particles to produce a wet plastic with wet particles distributed between the cut plastic pieces. The wet plastic with particles was then placed into a 2L graduated cylinder and 1.5L of water was added. The wet plastic with particles was rapidly stirred with a long rod for 30 seconds at ˜300 RPM. During the first 15 seconds of stirring, a small amount of the particles tended to “cling” to folded sections of wet film. However, upon additional stirring for the remaining 15 seconds, the remaining particles dislodged from the folded wet plastic. After stirring, the wet plastic was then float separated by density gradient over a ˜1 minute period and poured back into the filter funnel. The particles rapidly separated from the wet plastic in under 30 seconds and collected on the bottom of the graduated cylinder, which was an indication of good separability. The wet plastic within the filter funnel was removed, manually squeezed by hand, and placed on a stainless-steel sheet to dry overnight to produce the purer plastic. The wet particles at the bottom of the graduated cylinder were removed and dried for potential re-use. The dried particles were similar in size and appearance to the initial particles indicative of good durability and potential re-usability of the particles back into the method. A very small amount of fine glass particles were observed within the collected dried particles (<0.1 wt % of the initial 250 grams of particles). These fines can be separated through size exclusion and replenished with virgin and/or recycled particles as needed.

The appearance of the purer plastic was matte compared to the glossy observed in the first plastic. In addition, the ink was completely removed. The gloss value of the first plastic was 66.5% compared to 9.2% for the purer plastic or an 86% decrease in gloss (Table 1), which was indicative of extensive surface abrasion and high potential to remove tightly bound surface contamination. In addition, the gloss value of the purer plastic was significantly lower than the gloss value of the purer plastic from Comparative Example #1a (9.2% vs 56.7%), which was an indication of much improved surface abrasion and cleaning potential of the invention relative to known art. The dE of a compounded and melt pressed version of the purer plastic was 5.4 relative to a white standard sample. The % improvement in dE for the first plastic compared to the purer plastic was 78%, which is indicative of significant color improvement relative to water-based washing methods of Comparative Example 1 (78% vs 17%). Net, the use of particles in this simulated water washing process imparted significant abrasion and surface texture formation. In addition, the removal of tightly bound surface print was much improved relative to the known methods in the art.

### Example 1a (ii)-Surface Contaminant Removal of Surface Printed Film #1 Using Traditional Methods of Water Washing Involving Surfactants, Mechanical Agitation, and Crushed Glass Particles of the Current Invention (121)

A first plastic material, consisting of Surface Printed Film #1, was fed into a “simulated” water wash process including particles of the current invention. The “simulated” water wash process followed the guidance of the APR Guidance on Non-Caustic Wash of Polyolefins with modifications due to equipment limitations and to provide best-case removal performance. The first plastic was an opacified white base polyethylene film with extensive surface print and protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant. In addition, particles represented by 250 grams of crushed glass (Aldrich Silicone Dioxide 4-20 mesh/1 to 5 mm average diameter) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 1.8 to 1.0 to 4.7 for particles to first plastic to purification fluid) and allowed to continue for 20 minutes. After the 20 minutes, the stirring and heating were stopped and the first plastic/liquid mixture with particles was allowed to sit for ˜1 minute. After the 1 minute, the plastic/liquid mixture with particles was poured through a filter funnel to decant the liquid from the wet plastic and wet particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/cleaning fluid mixture with particles was poured through a filter funnel to decant most of the cleaning fluid from the plastic and particles to produce a wet plastic with wet particles distributed between the cut plastic pieces. The wet plastic with particles was then placed into a 2L graduated cylinder and 1.5L of water was added. The wet plastic with particles was rapidly stirred with a long rod for 30 seconds at ˜300 RPM. During the first 15 seconds of stirring, a small amount of the particles tended to “cling” to folded sections of wet film. However, upon additional stirring for the remaining 15 seconds, the remaining particles dislodged from the folded wet plastic. After stirring, the wet plastic was then float separated by density gradient over a ˜1 minute period and poured back into the filter funnel. The particles rapidly separated from the wet plastic in under 30 seconds and collected on the bottom of the graduated cylinder, which was an indication of good particle separability. The wet plastic within the filter funnel was removed, manually squeezed by hand, and placed on a stainless-steel sheet to dry overnight to produce the purer plastic. The wet particles at the bottom of the graduated cylinder were removed and dried for potential re-use. The dried particles were similar in size and appearance to the initial particles indicative of good particle durability and potential re-usability of the particles back into the method. A very small amount of fine glass particles were observed within the collected dried particles (<0.1 wt % of the initial 250 grams of particles). These can be separated through size exclusion and replenished with virgin and/or recycled particles as needed. The appearance of the purer plastic was matte compared to the glossy observed in the first plastic. In addition, the print was removed to a significant but not complete extent. The gloss value of the first plastic was 66.5% compared to 4.0% for the purer plastic (94% reduction), which was an indication of extensive surface abrasion and surface purification potential with the particles of the current invention (Table 1). In addition, the gloss value of the purer plastic was significantly lower than the gloss value of the purer plastic from Comparative Example #1b (4.0% vs 40.9%), which was an indication of much improved surface abrasion and cleaning potential of the invention relative to known art. The dE of a compounded and melt pressed version of the purer plastic was 13.9 relative to a white standard sample. The % improvement in dE for the first plastic compared to the purer plastic was 44%, which is indicative of significant color improvement relative to water-based washing methods of Comparative Example 1b (44% vs 3%). Net, the use of particles in a simulated known water washing process imparted abrasion and surface texture which are direct indicators of surface purification ability for the removal of surface dirt and the removal of tightly bound surface print.

### Example 1B-Surface Contaminant Removal of Surface Printed Film #1 Using Traditional Methods of Water Washing Involving Low pH, Surfactants, Mechanical Agitation, and Round Ceramic Particles of the Current Invention (131)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form 3 mm round ceramic tumbler media (Tonmp) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 1.2 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minutes. The stirring was stopped and the mixture was allowed to sit for ˜1 minutes. After ˜1 minutes, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. After stirring, the wet plastic was float separated from the particles by density gradient over the course of ˜1 minute and poured back into the filter funnel. The particles rapidly separated from the wet plastic in under 5 seconds with no tendency to cling or hang with the wet plastic, which was improved over Example 1b and an indication of excellent separability. The particles immediately separated from the wet plastic without any noticeable “clinging”. The round shape and high density of the particles allowed rapid and effective separation from the purification fluid. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles were identical in size and shape to the initial particles. In addition, no fines were evident and the collected mass of the particles matched the starting mass within experimental error, which was indicative of good particle durability. In addition, the durability of the round particles was greater than the irregular shaped glass particles of Examples 1a.

The appearance of the purer plastic was matte compared to the glossy observed in the first plastic. In addition, the surface print was largely removed but still contained some residual print. This residual print could have been removed with additional stirring time and/or other process modifications. The gloss value of the first plastic was 66.5% compared to 13.8% for the purer plastic (Table 1), which was indicative of moderate surface scrubbing and moderate potential to remove tightly bound surface contamination. In addition, the gloss value of the first plastic was significantly lower than the gloss value of the first plastic from Comparative Example #1a (13.8% vs 56.7%), which was an indication of much improved surface abrasion and cleaning potential. However, the gloss value was not as low as Example #1a (i) due to the reduced surface abrasion available with the smooth particles compared to the irregular shaped glass particles of Example 1a (i). The dE of a compounded and melt pressed version of the purer plastic was 13.8 relative to a white standard sample. The % improvement in dE for the first plastic compared to the purer plastic was 45%, which is indicative of significant color improvement relative to water-based washing methods of Comparative Example 1a wherein a 17% improvement was observed. However, the dE index and overall print removal were less than Example 1a (i) from the glass particles (45% vs 78%). Net, the use of particles in a simulated traditional water washing process imparted surface texture which is a direct indicator of surface cleaning ability for removal of surface dirt and the removal of tightly bound surface print. The utilization of particles with a round alumina surface provided slightly reduced ability to clean through abrasion compared to the glass from Example 1a (i) but with the benefit of improved particle separability and durability with improved potential to re-use in the process.

### Example 1c-Surface Contaminant Removal of Surface Printed Film #1 Using Traditional Methods of Water Washing Involving Low pH, Surfactants, Mechanical Agitation, and 60 Grit Silicone Carbide Particles of the Current Invention (132)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant and 2.5 grams of sodium hydroxide. In addition, 250 grams of particles in the form irregular 60 grit Silicone Carbide Tumbler Media (Baidoon) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring (volume ratio of 1.4 to 1.0 to 4.7 for particles to first plastic to purification fluid) vessel and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/cleaning fluid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles had great tendency to cling with the plastic due to their small size relative to the plastic. After stirring, the wet plastic was float separated from the particles by density gradient over a period of ˜ 1 minute and poured back into the filter funnel. The particles tended to cling to the plastic and remain in folded areas. In addition, the particles took a full 30 seconds to collect on the bottom and resided as a fluidized bed instead of a fully separated bed of particles, which was indicative of poor particle separability. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles were identical in size and shape to the initial particles. In addition, no fines were evident and the collected mass of particles matched the starting mass within experimental error, which was indicative of excellent particle durability. However, it was visually obvious that a small amount of the particles remained with the dried plastic and would represent unwanted contamination.

The appearance of the purer plastic was matte compared to the glossy observed in the first plastic. In addition, the print was largely removed but a small amount of residual ink remained on the purer plastic. The gloss value of the first plastic was 66.5% compared to 5.6% for the purer plastic (Table 1), which was indicative of moderate surface scrubbing and moderate potential to remove tightly bound surface contamination and slightly better than Example 1a (i). The dE of a compounded and melt pressed version of the purer plastic was 14.7 relative to a white standard sample (Table 1)). The % improvement in dE for the first plastic compared to the purer plastic was 41%, which is indicative of significant color improvement relative to water-based washing methods of Comparative Example 1a (i). However, the dE and overall print removal were less than Example 1a (i) from the glass particles plus separation was more difficult with these particles.

### Example 1D-Surface Contaminant Removal of Surface Printed Film #1 Using Traditional Methods of Water Washing Involving Low pH, Surfactants, Mechanical Agitation, and Round 3 mm Ceramic Particles of the Current Invention for Longer Times, Higher Particles Concentration, and Higher Temperatures (133)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective laquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant and 2.5 grams of sodium hydroxide. In addition, 500 grams of particles in the form 3 mm round ceramic tumbler media (Tonmp) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 85 to 95° C. The washing was initiated by adding 50 grams of the cut first plastic to the aqueous liquid in the stirring vessel (volume ratio of 2.3 to 1.0 to 4.7 for particles to first plastic to purification fluid) and allowed to continue for 80 minutes. After the 80 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜2 minutes. The stirring was stopped and the mixture was allowed to sit for ˜2 minutes. After ˜2 minutes, the wet plastic/cleaning fluid mixture with particles was poured through a filter funnel to decant most of the liquid from the plastic and particles to produce a wet plastic with particles. The wet plastic with particles was then placed into a 2L graduated cylinder and 1L of water was added. The wet plastic with particles was rapidly stirred with a long rod for 30 seconds at ˜300 RPM. The particles easily separated from the plastic in under 5 seconds and had no tendency to cling with the plastic, which was an indication of excellent separability. After stirring, the wet plastic was float separated from the particles by density gradient over the course of ˜1 minute and poured back into the filter funnel. The particles quickly collected at the bottom of the graduated cylinder and formed a concentrated layer. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles were identical in size and shape to the initial particles, which was indicative of good durability. In addition, no fines were evident and the collected mass of the particles matched the starting mass within experimental error.

The appearance of the purer plastic was matte compared to the glossy observed in the first plastic. In addition, the print was completely removed, which was indicative of excellent surface abrasion. The gloss value of the first plastic was 66.5% compared to 12.2% for the purer plastic (Table 1), which was indicative of extensive surface scrubbing and extensive potential to remove tightly bound surface contamination. The % reduction in gloss was slightly higher than Example 1b, which suggests the longer abrasion time, higher temperature, and higher particle concentration were somewhat effective at increasing abrasion. After compounding the first and purer plastic to homogenize color, the overall appearance of the purer plastic was much improved over the first plastic (8.5 vs 24.8 for a 66% improvement). The increased abrasion resulted in a significant improvement in color as represented by the dE of 13.7 for Example 1b compared to 8.5 in the current example and had color similar to virgin white material. The use of greater time, greater concentration, and higher temperature provided outstanding abrasion/surface cleaning.

### Example 1e-Surface Contaminant Removal of Surface Printed Film #1 Using Traditional Methods of Water Washing Involving Low pH, Surfactants, Mechanical Agitation, and SS Needle-like Cylindrical (TOAAOT SS Tumbler Media) Particles of the Current Invention (135)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form SS Needles (TOAAOT SS Tumbler Media) (0.039″ Diameter, 0.255″ Length) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 0.6 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜ 1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles immediately separated from the wet plastic without any noticeable “clinging”, which was indicative of good separability, but not as good as the ceramic round particles of Example 1b. After stirring, the wet plastic was float separated from the particles by density gradient over the course of ˜1 minute and poured back into the filter funnel. The particles rapidly separated from the wet plastic in under 10 seconds with no tendency to cling or hang with the wet plastic. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles were identical in size and shape to the initial particles. In addition, no fines were evident and the collected mass of the particles matched the starting mass within experimental error, which was indicative of excellent durability. Thus, the SS cylindrical particles were much easier to separate from the cleaning fluid and plastic compared to the irregular particles from Example 1a (i). In addition, the durability of the SS particles was greater than the irregular shaped glass particles and the ceramic.

The appearance of the purer plastic was matte compared to the glossy observed in the first plastic. In addition, the surface print was largely removed with only small amounts of residual print that could have been removed with additional time. The gloss value of the first plastic was 66.5% compared to 9.8% for the purer plastic (Table 1), which was indicative of moderate surface scrubbing and moderate potential to remove tightly bound surface contamination. In addition, the gloss value of the purer plastic was significantly lower than the gloss value of the purer plastic from Comparative Example #1a (9.8% vs 56.7%), which was an indication of much improved surface scrubbing and cleaning potential. The gloss value of the purer plastic was similar to that obtained in Example #1a (i) indicating similar surface abrasion and ability to clean the surface (9.8% vs 9.2%). The stainless-steel cylinders of the current example were easier to separate and had improved durability due to the absence of any fines from the particles. After compounding the first and purer plastic to homogenize color, the overall appearance of the purer plastic was much improved over the first plastic and had color similar to virgin white material (dE of 8.0 compared to 24.8). Net, the use of particles in a simulated traditional water washing process imparted surface texture which is a direct indicator of surface cleaning ability for removal of surface dirt and the removal of tightly bound surface print. The utilization of stainless-steel cylinders particles provided slightly reduced ability to clean surface through abrasion but with the benefit of improved particle longevity/reusability, improved separation, and improved potential to re-use in the process relative to the glass particles of Example 1a (i).

### Example if-Surface Contaminant Removal of Surface Printed Film #1 Using Traditional Methods of Water Washing Involving Low pH, Surfactants, Mechanical Agitation, and ⅛″ Stainless Steel Ballcone Satellites (TOAAOT SS Tumbler Media) Particles of the Current Invention (136)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form of ⅛″ Stainless Steel Ballcone Satellites (TOAAOT SS Tumbler Media) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 0.6 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜ 1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles immediately separated from the wet plastic without any noticeable “clinging”, which was indicative of excellent separability. After stirring, the wet plastic was float separated from the particles by density gradient over the course of ˜1 minute and poured back into the filter funnel. The particles rapidly separated from the wet plastic in under 10 seconds with no tendency to cling or hang with the wet plastic.

The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles were identical in size and shape to the initial particles. In addition, no fines were evident and the collected mass of the particles matched the starting mass within experimental error, which was indicative of excellent particle durability. Thus, the SS satellite particles were much easier to separate from the cleaning fluid and plastic compared to the irregular particles from Example 1a (i). In addition, the durability of the SS particles was greater than the irregular shaped glass particles and the alumina silica media in the prior examples.

The appearance of the purer plastic was matte compared to the glossy observed in the first plastic. In addition, the surface print was largely removed with only small amounts of residual print that could have been removed with additional time. The gloss value of the first plastic was 66.5% compared to 7.4% for the purer plastic (Table 1), which was indicative of extensive surface scrubbing and potential to remove tightly bound surface contamination. In addition, the gloss value of the first plastic was significantly lower than the gloss value of the first plastic from Comparative Example #1a (7.4% vs 56.7%), which was an indication of much improved surface scrubbing and cleaning potential. The gloss value was similar to Example #1a (i) (7.4% vs 9.2%). After compounding the first and purer plastic to homogenize color, the overall appearance of the purer plastic was much improved over the first plastic (dE of 8.2 vs 24.8). Net, the use of particles in a simulated traditional water washing process imparted surface texture which is a direct indicator of surface cleaning ability for removal of surface dirt and the removal of tightly bound surface print. The utilization of stainless-steel satellite particles provided similar ability to clean surface relative to the glass of Example 1a (i) through abrasion and with the benefit of improved particle longevity/reusability, improved separation, and improved potential to re-use in the process.

### Example 1g-Surface Contaminant Removal of Surface Printed Film #1 Using Traditional Methods of Water Washing Involving Low pH, Surfactants, Mechanical Agitation, and a Mixture of Stainless-Steel Needle-like Cylinders and Oblong Cylinders Particles of the Current Invention (137)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form of a mixture of Stainless-Steel Narrow Cylinders and Oblong Cylinders (G24-4 Media) were added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 0.6 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles immediately separated from the wet plastic without any noticeable “clinging”, which was indicative of good separability. The separability was not as good as the round ceramic or Satellite Stainless-Steel particles. After stirring, the wet plastic was float separated from the particles by density gradient over the course of ˜1 minute and poured back into the filter funnel. The particles rapidly separated from the wet plastic in under 15 seconds with no tendency to cling or hang with the wet plastic. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles were identical in size and shape to the initial particles. In addition, no fines were evident and the collected mass of the particles matched the starting mass within experimental error, which was indicative of excellent durability. Thus, the SS particles were much easier to separate from the cleaning fluid and plastic compared to the irregular particles from Example 1a (i). In addition, the durability of the SS was greater than the irregular shaped glass particles.

The appearance of the purer plastic was matte compared to the glossy observed in the first plastic. In addition, the surface print was largely removed with only small amounts of residual print that could have been removed with additional time. The gloss value of the first plastic was 66.5% compared to 7.8% for the purer plastic (Table 1), which was indicative of excellent surface scrubbing and potential to remove tightly bound surface contamination. In addition, the gloss value of the purer plastic was significantly lower than the gloss value of the purer plastic from Comparative Example #1 (7.8% vs 56.7%), which was an indication of much improved surface abrasion and cleaning potential. The gloss value was similar to Example #1a (i) (7.8% vs 9.2%). After compounding the first and purer plastic to homogenize color, the overall appearance of the purer plastic was much improved over the first plastic (dE of 11.5 vs 24.8 relative to the white standard) and much improved of the known process of Comparative Example 1a (dE of 20.7). Net, the use of particles in a simulated traditional water washing process imparted surface texture which is a direct indicator of surface cleaning ability for removal of surface dirt and the removal of tightly bound surface print. The utilization of particles with a mix of stainless-steel particles provided slightly reduced ability to clean surface through abrasion compared to Example 1a (i), but with the benefit of improved separation, longevity, and improved potential to re-use in the process.

### Example 1h-Surface Contaminant Removal of Surface Printed Film #1 Using Traditional Methods of Water Washing Involving Low pH, Surfactants, Mechanical Agitation, and TiO₂/Polyethylene Masterbatch Pellets Particles of the Current Invention (138)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form of a TiO₂/polyethylene masterbatch pellet particles (Ampacet 110375 White Polyethylene MB) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 3.1 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜ 1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles immediately separated from the wet plastic without any noticeable “clinging”, which was indicative of good separability (less than ceramic and stainless-steel round particles). However, there was noticeably degradation of the particles due to white coloration of the purification fluid, which was indicative of poor durability. After stirring, the wet plastic was float separated from the particles by density gradient over the course of ˜1 minute and poured back into the filter funnel. The particles separated from the wet plastic in under 30 seconds with only slight tendency to cling or hang with the wet plastic. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles appeared identical to the starting material despite the obvious loss of TiO₂ into the purification fluid. Extensive fines were evident in the fluid. However, the loss of the TiO₂ and polyethylene into the purer plastic would not significantly impact the overall quality or appearance of the purer plastic if white is the ultimate target.

The appearance of the purer plastic was only slightly matte compared to the glossy observed in the first plastic. In addition, the surface print was only partially removed compared to most of the other particles of the present invention. However, the removal was superior to the standard washing process of Comparative Example 1a. The gloss value of the first plastic was 66.5% compared to 19.4% for the purer plastic (Table 1), which was indicative of moderate surface abrasion and moderate potential to remove tightly bound surface contamination. In addition, the gloss value of the purer plastic was lower than the gloss value of the purer plastic from Comparative Example #1a (19.4% vs 56.7%), which was an indication of improved surface abrasion relative to the known process. However, the gloss value was not as low as Example #1a (i) due to the reduced surface abrasion available with the TiO₂/polyethylene masterbatch particles compared to the irregular shaped glass particles of Example 1a (i). The dE of a compounded and melt pressed version of the purer plastic was 19.8 relative to a white standard sample (Table 1)). The % improvement in dE for the first plastic compared to the purer plastic was 20%, which was indicative of less color improvement relative to the other particles of the present invention but with the advantage of low contamination potential of fines from degradation of the particulate.

### Example 1i-Surface Contaminant Removal of Surface Printed Film #1 Using Traditional Methods of Water Washing Involving Low pH, Surfactants, Mechanical Agitation, and PET Pellets Particles of the Current Invention (139)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form of a PET pellet particles (Alpek Laser+C60A) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 3.4 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1L of water was added. The wet plastic with particles was rapidly stirred with a long rod for 30 seconds at ˜300 RPM. The particles immediately separated from the wet plastic without any noticeable “clinging”. After stirring, the wet plastic was float separated from the particles by density gradient over the course of ˜1 minute and poured back into the filter funnel. The particles separated from the wet plastic in under 30 seconds with only slight tendency to cling or hang with the wet plastic, which was indicative of good separability. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles appeared identical to the starting, which was indicative of good particle durability. No fines were evident in the fluid.

The appearance of the purer plastic was somewhat matte compared to the glossy observed in the first plastic. In addition, the surface print was partially removed. The removal was superior to the standard washing process of Comparative Example 1. The gloss value of the first plastic was 66.5% compared to 13.4% for the purer plastic (Table 1), which was indicative of surface abrasion and potential to remove tightly bound surface contamination. The gloss value of the purer plastic was somewhat inferior to the ceramic and stainless-steel particles. The dE of a compounded and melt pressed version of the purer plastic was 13.2 relative to a white standard sample (Table 1)). The % improvement in dE for the first plastic compared to the purer plastic was 47%, which was indicative of moderate color improvement relative to water-based washing methods of Comparative Example 1a (47% vs 17%).

### Example 1J-Surface Contaminant Removal of Surface Printed Film #1 Using Traditional Methods of Water Washing Involving Low pH, Surfactants, Mechanical Agitation, and Mixture of Ceramic of Various Size and Shapes Particles of the Current Invention (140)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in a mixture of ceramics of various size and shapes particles (Polly Plastics Small and Large Cylinder Mix; 10 mm×16 mm ceramic cylinders and 5 mm×10 mm ceramic cylinders) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 1.2 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles immediately separated from the wet plastic without any noticeable “clinging”, which was indicative of good separability. After stirring, the wet plastic was float separated from the particles by density gradient over the course of ˜1 minute and poured back into the filter funnel. The particles separated from the wet plastic in under 10 seconds with no tendency to cling or hang with the wet plastic. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles appeared identical to the starting. An extremely small quantity of fines were evident in the fluid, which was indicative of good particle durability.

The appearance of the purer plastic was matte compared to the glossy observed in the first plastic. In addition, the surface print was largely removed. The removal was superior to the standard washing process of Comparative Example 1. The gloss value of the first plastic was 66.5% compared to 6.1% for the purer plastic (Table 1), which was indicative of surface abrasion and potential to remove tightly bound surface contamination. In addition, the gloss value of the purer plastic was lower than the gloss value of the purer plastic from Comparative Example #1a (6.1% vs 56.7%), which was an indication of improved surface abrasion and cleaning potential. The dE of a compounded and melt pressed version of the purer plastic was 12.9 relative to a white standard sample (Table 1)). The % improvement in dE for the first plastic compared to the purer plastic was 48%, which was indicative of moderate color improvement relative to water-based washing methods of Comparative Example 1a (48% vs 17%). The dE and overall print removal were less than Example 1a (i) from the glass particles (48% vs 78%).

EXAMPLE 1k-Surface Contaminant Removal of Surface Printed Film #1 Using Traditional Methods of Water Washing Involving Low pH, Surfactants, Mechanical Agitation, and Sand Particles of the Current Invention (141).

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and a protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was prepared by adding 250 grams of DI water to a 2L baffled round bottom flask along with 0.6 grams of Triton X-100 surfactant and 2.5 grams of sodium hydroxide. In addition, 250 grams of particles in the form of standard sand (Royal Ram Natural Beach Sand) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 1.8 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/liquid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles separated slowly from the wet plastic with noticeable “clinging”, which was indicative of somewhat poor separability. After stirring, the wet plastic was float separated from the particles by density gradient over the course of ˜1 minute and poured back into the filter funnel. The particles separated from the wet plastic in under 30 seconds with only slight tendency to cling or hang with the wet plastic. The wet plastic within the filter funnel was removed, manually squeezed by hand, and placed on a stainless-steel sheet to dry overnight to produce the purer plastic. The wet particles remained at the bottom of the graduated cylinder and were removed and dried for potential re-use. The dried particles appeared identical to the starting. No fines were evident in the fluid, but some residual remained on portions of the first plastic, which was indicative of good particle durability.

The appearance of the purer plastic was matte compared to the glossy observed in the first plastic. In addition, the surface print was partially removed. The removal was superior to the standard washing process of Comparative Example 1a. The gloss value of the first plastic was 66.5% compared to 7.3% for the purer plastic (Table 1), which was indicative of surface abrasion and potential to remove tightly bound surface contamination. The gloss value was similar to Example #1a (i) (7.3% vs 9.2%). The dE of a compounded and melt pressed version of the purer plastic was 14.8 relative to a white standard sample (Table 1)). The % improvement in dE for the first plastic compared to the purer plastic was 40%, which was indicative of moderate color improvement relative to water-based washing methods of Comparative Example 1a (40% vs 17%). The dE and overall print removal were less than Example 1a (i) from the glass particles (14.8 vs 5.4).

### Example 11-Surface Contaminant Removal of Surface Printed Film #1 Using Traditional Methods of Water Washing Involving Low pH, Surfactants, Mechanical Agitation, and Crushed Glass Particles of the Current Invention (142)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant and 2.5 grams of sodium hydroxide. In addition, particles represented by 125 grams of crushed glass (Aldrich Silicone Dioxide 4-20 mesh/1 to 5 mm average diameter) was added to the flask. Note: This was half the amount of particles that were used in Example 1a (i). The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 0.9 to 1.0 to 4.7 for particles to first plastic to purification fluid) and allowed to continue for 20 minutes. After the 20 minutes, the stirring and heating were stopped and the first plastic/liquid mixture with particles was allowed to sit for ˜1 minute. After the 1 minutes, the plastic/liquid mixture with particles was poured through a filter funnel to decant the liquid from the wet plastic and wet particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/cleaning fluid mixture with particles was poured through a filter funnel to decant most of the cleaning fluid from the plastic and particles to produce a wet plastic with wet particles distributed between the cut plastic pieces. The wet plastic with particles was then placed into a 2L graduated cylinder and 1.5L of water was added. The wet plastic with particles was rapidly stirred with a long rod for 30 seconds at ˜300 RPM. During the first 15 seconds of stirring, a small amount of the particles tended to “cling” to folded sections of wet film, which was indicative of good separability. However, upon additional stirring for the remaining 15 seconds, the remaining particles dislodged from the folded wet plastic. After stirring, the wet plastic was then float separated by density gradient over a ˜1 minute period and poured back into the filter funnel. The particles rapidly separated from the wet plastic in under 30 seconds and collected on the bottom of the graduated cylinder. The wet plastic within the filter funnel was removed, manually squeezed by hand, and placed on a stainless-steel sheet to dry overnight to produce the purer plastic. The wet particles at the bottom of the graduated cylinder were removed and dried for potential re-use. The dried particles were similar in size and appearance to the initial particles indicative of durability and potential re-usability of the particles back into the method. A very small amount of fine glass particles were observed within the collected dried particles (<0.1 wt % of the initial 250 grams of particles), which was indicative of fair durability. These can be separated through size exclusion and replenished with virgin and/or recycled particles as needed.

The appearance of the purer plastic was matte compared to the glossy observed in the first plastic. In addition, the ink was completely removed. The gloss value of the first plastic was 66.5% compared to 3.8% for the purer plastic or a 94% decrease in gloss (Table 1), which was indicative of extensive surface abrasion and high potential to remove tightly bound surface contamination. In addition, the gloss value of the purer plastic was significantly lower than the gloss value of the purer plastic from Comparative Example #1a (3.8% vs 56.7%), which was an indication of much improved surface abrasion and cleaning potential of the invention relative to known art. The gloss value was slightly improved relative to Example 1a (i) (3.8% vs 9.2%), which suggests that the drop in particulate concentration did not significantly alter the abrasion. The dE of a compounded and melt pressed version of the purer plastic was 5.4 relative to a white standard sample. The % improvement in dE for the first plastic compared to the purer plastic was 78%, which was indicative of significant color improvement relative to water-based washing methods of

Comparative Example 1a (78% vs 17%). The dE was identical to Example 1a (i) (5.4 vs 5.4), which suggests that the drop in particulate concentration did not significantly alter the abrasion.

### Example 1m-Surface Contaminant Removal of Surface Printed Film #1 Using Traditional Methods of Water Washing Involving Low pH, Surfactants, Mechanical Agitation, and Crushed Glass Particles of the Current Invention (143)

A first plastic material, consisting of Surface Printed Film #1, was fed into a “simulated” water wash process including particles of the current invention. The “simulated” water wash process followed the guidance of the APR Guidance on Caustic Wash of Polyolefins with modifications due to equipment limitations and to provide best-case removal performance. The first plastic was an opacified white base polyethylene film with extensive surface print and protective lacquer. The base film used in the first plastic was glossy and without significant microtexture as represented by its high gloss of 66.5% at 60° (Table 1). The dE of a compounded and melt pressed version was 24.8 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant and 2.5 grams of sodium hydroxide. In addition, particles represented by 63 grams of crushed glass (Aldrich Silicone Dioxide 4-20 mesh/1 to 5 mm average diameter) was added to the flask. Note: This was 25% of the amount of particles that were used in Example 1a (i) and 50% less than Example 11. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 0.4 to 1.0 to 4.7 for particles to first plastic to purification fluid) and allowed to continue for 20 minutes. After the 20 minutes, the stirring and heating were stopped and the first plastic/liquid mixture with particles was allowed to sit for ˜1 minute. After the 1 minutes, the plastic/liquid mixture with particles was poured through a filter funnel to decant the liquid from the wet plastic and wet particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜1 minute. After ˜1 minute, the wet plastic/cleaning fluid mixture with particles was poured through a filter funnel to decant most of the cleaning fluid from the plastic and particles to produce a wet plastic with wet particles distributed between the cut plastic pieces. The wet plastic with particles was then placed into a 2L graduated cylinder and 1.5L of water was added. The wet plastic with particles was rapidly stirred with a long rod for 30 seconds at ˜300 RPM. During the first 15 seconds of stirring, a small amount of the particles tended to “cling” to folded sections of wet film, which was indicative of good separability. However, upon additional stirring for the remaining 15 seconds, the remaining particles dislodged from the folded wet plastic. After stirring, the wet plastic was then float separated by density gradient over a ˜1 minute period and poured back into the filter funnel. The particles rapidly separated from the wet plastic in under 30 seconds and collected on the bottom of the graduated cylinder. The wet plastic within the filter funnel was removed, manually squeezed by hand, and placed on a stainless-steel sheet to dry overnight to produce the purer plastic. The wet particles at the bottom of the graduated cylinder were removed and dried for potential re-use. The dried particles were similar in size and appearance to the initial particles indicative of the durability and potential re-usability of the particles back into the method. A very small amount of fine glass particles were observed within the collected dried particles (<0.1 wt % of the initial 250 grams of particles), which was indicative of fair particle durability. These can be separated through size exclusion and replenished with virgin and/or recycled particles as needed.

The appearance of the purer plastic was matte compared to the glossy observed in the first plastic. The ink was almost completely removed but not as good as Example 1a (i) and Example 11 where the particulate concentration was higher. The gloss value of the first plastic was 66.5% compared to 8.3% for the purer plastic or an 60% decrease in gloss (Table 1), which was indicative of extensive surface abrasion and high potential to remove tightly bound surface contamination. In addition, the gloss value of the purer plastic was significantly lower than the gloss value of the purer plastic from Comparative Example #1 (8.3% vs 56.7%), which was an indication of much improved surface abrasion and cleaning potential of the invention relative to known art. The gloss value was similar to that of Example 1a (i) (8.3% vs 9.2%), which suggests that the further drop in particulate concentration did not significantly lower surface abrasion. The dE of a compounded and melt pressed version of the purer plastic was 9.9 relative to a white standard sample. The % improvement in dE for the first plastic compared to the purer plastic was 60%, which was indicative of significant color improvement relative to water-based washing methods of Comparative Example 1a. However, the dE of the purer plastic was higher than that obtained from the purer plastics of Example 1a (i) and Example 11 (9.9 vs 5.4 vs 5.4), which suggests a slight decrease in print removal and surface purification despite similar levels of abrasion. In addition, the lower particle concentration started to impact the overall purification at this concentration level, but still may be acceptable depending upon the final color requirements for the targeted end market.

### Example 2-Surface Contaminant Removal of Surface Printed Film #2 Using Traditional Methods of Water Washing Involving Low pH, Surfactants, Mechanical Agitation, and Crushed Glass Particles of the Current Invention

A first plastic material, consisting of Surface Printed Film #2, was fed into a “simulated” water wash process including crushed glass particles of the current invention. The “simulated” water wash process followed the guidance of the APR Guidance on Caustic Wash of Polyolefins with modifications due to equipment limitations and to provide best-case removal performance.

The first plastic was an opacified white base polyethylene film with extensive surface print. The base film used in the first plastic was glossy and without significant microtexture as represented by its somewhat high gloss of 30.7% (Table 1). The dE of a compounded and melt pressed version was 18.2 relative to a white standard sample. The first plastic was cut into ˜1.5 cm×˜1.5 cm pieces.

The cleaning fluid was produced by adding 250 grams of DI water to a 2L baffled round bottom flask along with 0.6 grams of Triton X-100 surfactant and 2.5 grams of sodium hydroxide. In addition, 250 grams of particles in the form of crushed glass (Aldrich Silicone Dioxide 4-20 mesh/1 to 5 mm average diameter) was added to the flask. The flask was outfitted with a mechanical propeller/paddle stirrer, one reflux condenser, and one heat jacket. The mechanical stirring was set to ˜500 rpm to achieve rapid convection. The heating jacket was controlled by a variable voltage transformer. The heat was applied to rapidly bring the temperature of the aqueous liquid to about 80 to 85° C. The washing was initiated by adding 50 grams of the cut first plastic to the aqueous liquid in the stirring vessel (volume ratio of 1.8 to 1.0 to 4.7 for particles to first plastic to purification fluid) and allowed to continue for 20 minutes. After the 20 minutes, the stirring and heating were stopped and the first plastic/cleaning fluid mixture with particles was allowed to sit for ˜1 minute. After the 1 minute, the plastic/cleaning fluid mixture with particles was poured through a filter funnel to decant the liquid from the wet plastic and particles. The wet plastic and particles were then re-introduced to the 2L baffled round bottom and ˜500 grams of water was added to the round bottom and mixing was re-started at 400 RPM for ˜1 minute. The stirring was stopped and the mixture was allowed to sit for ˜ 1 minute. After ˜ 1 minute, the wet plastic/cleaning fluid mixture with particles was poured through a filter funnel to decant most of the liquid from the plastic and particles to produce a wet plastic with particles. The wet plastic with particles was then placed into a 2L graduated cylinder and 1.5L of water was added. The wet plastic with particles was rapidly stirred with a long rod for 30 seconds at ˜300 RPM. The particles had a slight tendency to cling to and within the folded sections of the plastic, which was indicative of good separability. After stirring, the wet plastic was then floated to the top of the water by density gradient over the course of ˜1 minute and poured back into the filter funnel. The wet plastic within the filter funnel was removed, manually squeezed by hand, and placed on a stainless-steel sheet to dry overnight to produce the purer plastic. The particles remained at the bottom of the graduated cylinder and were removed and dried for potential re-use. The collected particles contained some fines, which was indicative of fair particle durability.

The appearance of the purer plastic was matte compared to the glossy observed in the first plastic. In addition, all of the surface print was effectively removed. A slight green overtone was observed likely due to slight adsorption of the removed ink within the plastic. The gloss value of the first plastic was 30.7% compared to 7.6% for the purer plastic (Table 1). The gloss value of the first plastic (7.6%) was significantly lower than the gloss value of the first plastic from Comparative Example #2 (25.6%), which was an indication of much improved surface scrubbing and cleaning potential compared to a typical water washing recycling process. The dE of a compounded and melt pressed version of the purer plastic was 15.8 relative to a white standard sample (Table 1)). The % improvement in dE for the first plastic compared to the purer plastic was 13%, which was indicative of modest color improvement relative to water-based washing methods of Comparative Example 2 (13% vs 0%). Net, the use of particles in a simulated traditional water washing process increased surface texture (a direct indicator of surface cleanliness for dirt and other loosely bound dirt and other particles contamination) and improved the removal of surface print.

### Example 3a—Surface Contaminant Removal of Printed Film #1 Using Known Methods of Solvent Washing involving Mechanical Agitation and Crushed Glass Particles of the Current Invention. (125)

A first plastic material, consisting of Surface Printed Film #1, was fed into a “simulated” solvent wash process with particles of the current invention. The first plastic was an opacified white base polyethylene film with extensive surface print and protective lacquer. The base film used in the first plastic was glossy and without significant microtexture as represented by its high gloss of 66.5% (Table 1). The dE of a compounded and melt pressed version was 24.8 relative to a white standard sample. The first plastic was cut into ˜1.5 cm×˜1.5 cm pieces.

The cleaning fluid was produced by adding 500 grams of ethyl acetate to a 2L baffled round bottom flask. The flask was outfitted with a mechanical paddle stirrer, one reflux condenser, and one heat jacket. In addition, 250 grams of particles in the form of crushed glass (Aldrich Silicone Dioxide 4-20 mesh/1 to 5 mm average diameter) were added to the ethyl acetate. The mechanical stirring was set to 400 rpm to achieve rapid convection. The heating jacket was controlled by a variable voltage transformer. The heat was applied to rapidly bring the temperature of the liquid to the boiling point of ethyl acetate (˜77° C.). Once boiling was reached, the heat was adjusted to achieve a reflux rate of approximately 1 gram per second. The solvent washing was initiated by adding 50 grams of the cut first plastic to the liquid in the stirring vessel (volume ratio of 1.8 to 1.0 to 10.4 for particles to first plastic to purification fluid) and allowed to continue for 25 minutes. After the 25 minutes, the ethyl acetate was decanted from the flask and 250 grams of fresh ethyl acetate at room temperature was added to the flask. Stirring was briefly re-initiated at ˜400 RPM for ˜1 minute. After the brief stirring, the ethyl acetate was decanted from the flask and another 250 grams of fresh ethyl acetate at room temperature was added to the flask. Stirring was again briefly re-initiated at ˜400 RPM for ˜1 minute. After the brief stirring, the ethyl acetate was decanted from the flask. The wet plastic and particles mixture was removed and placed into a 2L graduated cylinder. 1.5L of DI water was added to the graduated cylinder and then rapidly stirred with a stainless-steel rod at ˜300 RPM for ˜1 minute. After stirring, the wet plastic was floated to the top over the course of ˜1 minute and then poured into a filter funnel to isolate the wet plastic from the water. The particles had a tendency to cling to the plastic but separated after the stirring, which was indicative of good separability. The particles collected at the bottom of the graduated cylinder as a compact continuous layer. The resulting plastic was placed on a stainless-steel pan and allowed to dry overnight to produce the purer plastic. The particles were removed from the graduated cylinder and dried for potential re-use in the process or a different process. There was a small amount of fines visible within the collected particles, which was an indication of fair durability.

The appearance of the purer plastic was matte compared to glossy in the first plastic. In addition, all the print was removed. The gloss value of the first plastic was 66.5% compared to 16.2% for the purer plastic (Table 1). In addition, the gloss value of the first plastic (16.2%) was significantly lower than the gloss value of the first plastic from Comparative Example #3 (51.5%), which was an indication of improved surface abrasion and cleaning potential of the particles. The dE of a compounded and melt pressed version of the purer plastic was 3.8 relative to a white standard sample (Table 1)). The % improvement in dE for the first plastic compared to the purer plastic was 85%, which was indicative of outstanding color improvement relative to water-based washing methods of Comparative Example 3 (85% vs 60%). The dE of the purer plastic was similar to that of the reference white plastic (3.8 vs 0.0). Net, a solvent based traditional method for solvent washing with particles offered significant improvements in surface cleaning potential including potential to remove surface printed inks.

### Example 3b-Surface Contaminant Removal of Printed Film #1 Using Known Methods of Solvent Washing involving Mechanical Agitation and 3 mm Round Ceramic Particles of the Current Invention. (134)

A first plastic material, consisting of Surface Printed Film #1, was fed into a “simulated” solvent wash process. The first plastic was an opacified white base polyethylene film with extensive surface print and protective lacquer. The base film used in the first plastic was glossy and without significant microtexture as represented by its high gloss of 66.5% (Table 1). The dE of a compounded and melt pressed version was 24.8 relative to a white standard sample. The first plastic was cut into ˜1.5 cm×˜1.5 cm pieces.

The cleaning fluid was produced by adding 500 grams of ethyl acetate to a 2L baffled round bottom flask. The flask was outfitted with a mechanical paddle stirrer, one reflux condenser, and one heat jacket. In addition, 250 grams of scrubbies in the form of 3 mm round ceramic tumbler media (Tonmp) were added to the ethyl acetate. The mechanical stirring was set to 400 rpm to achieve rapid convection. The heating jacket was controlled by a variable voltage transformer. The heat was applied to rapidly bring the temperature of the liquid to the boiling point of ethyl acetate (˜77° C.). Once boiling was reached, the heat was adjusted to achieve a reflux rate of approximately 1 gram per second. The solvent washing was initiated by adding 50 grams of the cut first plastic to the liquid in the stirring vessel (volume ratio of 1.2 to 1.0 to 10.4 for particles to first plastic to purification fluid) and allowed to continue for 25 minutes. After the 25 minutes, the ethyl acetate was decanted from the flask and 250 grams of fresh ethyl acetate at room temperature was added to the flask. Stirring was briefly re-initiated at ˜400 RPM for ˜1 minute. After the brief stirring, the ethyl acetate was decanted from the flask and another 250 grams of fresh ethyl acetate at room temperature was added to the flask. Stirring was again briefly re-initiated at ˜400 RPM for ˜1 minute. After the brief stirring, the ethyl acetate was decanted from the flask. The wet plastic and particles mixture was removed and placed into a 2L graduated cylinder. 1.5L of DI water was added to the graduated cylinder and then rapidly stirred with a stainless-steel rod at ˜300 RPM for ˜1 minute. After stirring, the wet plastic was floated to the top over the course of ˜1 minute and then poured into a filter funnel to isolate the wet plastic from the water. The particles easily, quickly, and completely separated from the plastic and collected at the bottom of the graduated cylinder as a dense continuous layer, which was indicative of good separability. The resulting plastic was placed on a stainless-steel pan and allowed to dry overnight to produce the purer plastic. The particles were removed from the graduated cylinder and dried for potential re-use in the process or a different process. The mass of particles recovered matched the ingoing mass of particles within experimental error. In addition, no fines or change in shape were observed indicating durability and re-usability of these particles, which was indicative of good durability.

The appearance of the purer plastic was matte compared to glossy in the first plastic. In addition, the ink was completely removed similar to Example 3a. The gloss value of the first plastic was 66.5% compared to 14.4% for the purer plastic (Table 1). In addition, the gloss value of the first plastic (14.4%) was significantly lower than the gloss value of the first plastic from Comparative Example #3 (51.5%), which was an indication of improved surface abrasion and associated potential to remove surface print with the particles. The dE of a compounded and melt pressed version of the purer plastic was 5.7 relative to a white standard sample (Table 1)). The % improvement in dE for the first plastic compared to the purer plastic was 77%, which was indicative of superior color improvement relative to water-based washing methods of Comparative Example 3. In addition, the dE of the purer plastic was significantly lower than that of the first plastic and similar to that of the purer plastic from Example #3a and similar to virgin white plastic (5.7 vs 3.8 vs 0.0). Net, a solvent based traditional method for washing with particles offered significant improvements in surface cleaning potential including potential to remove surface printed inks. In the case of solvent washing processes, the use of less aggressive and more durable particles/recyclable particles may be possible to achieve the same level of surface cleaning relative to water processes.

### Example 4-Cleaning of Reclaimed Film Bale Using Methods of Aqueous Washing Involving Mechanical Agitation and 3 mm Stainless-Steel Satellites of the Current Invention

A film bale composed of predominately LLDPE/LDPE material that is surface printed is fed to the method involving multiple steps. In step 1, the film bale is debaled using known debaling methods. In step 2, the film is sorted to remove non-polymer contaminants. In step 3, the film is shredded to produce the first plastic. The first plastic is fed into step 4 involving a large continuous stirred tank containing a motorized impeller operating at 400 RPM. The purification fluid is an aqueous mixture involving 0.5 wt % sodium hydroxide and 0.3 wt % Triton-X100 surfactant. The first plastic feed rate is such that a 4:1 ratio of purification fluid to first plastic is achieved in the CST. In addition, the aqueous mixture contains 3 mm stainless steel satellite particles at a volume ratio of 0.5 to 1 of the first plastic within the CST at a given time. The mean residence time for the plastic within the CST is 20 minutes. The plastic, particles, and purification fluid are separated from each other at the exit of the CST or in any number of steps following the CST. The particles are purified and returned at >99% back into the CST. The purification fluid is purified and returned at >50% back into the CST. The plastic exits the various separations as a wet plastic. The wet plastic is rinsed and then dried to produce a dry plastic in the form of shreds similar to the starting material. The gloss of the plastic shreds compared to the first plastic is decreased by >50%. The shreds are densified, extruded, devolatilized, and pelletized to produce the purer plastic. The % improvement of the dE for the purer plastic compared to the first plastic >25% relative to the color standard of the base unprinted first plastic.

### Example 5-Cleaning of Reclaimed Film Bale Using Methods of Solvent Washing Involving Mechanical Agitation and 3 mm Stainless-Steel Satellites of the Current Invention

A film bale composed of predominately LLDPE/LDPE material that is surface printed is fed to the method. In step 1, the film bale is debaled using known debaling methods. In step 2, the film is sorted to remove non-polymer contaminants. In step 3, the film is shredded to produce the first plastic. The first plastic is fed into step 4 involving a large continuous stirred tank containing a motorized impeller operating at 400 RPM. The purification fluid is acetone. The first plastic feed rate is such that a 10:1 ratio of purification fluid to first plastic is achieved in the CST. In addition, the mixture contains 3 mm stainless steel satellite particles at a volume ratio of 0.5 to 1 of the first plastic within the CST at a given time. The mean residence time for the plastic within the CST is 30 minutes. The plastic, particles, and purification fluid are separated from each other at the exit of the CST or in any number of steps following the CST. The particles are purified and returned at >99% back into the CST. The purification fluid is purified and returned at >50% back into the CST. The plastic exits the various separations as a wet plastic. The wet plastic is rinsed and then dried to produce a dry plastic in the form of shreds similar to the starting material. The gloss of the plastic shreds compared to the first plastic is decreased by >50%. The shreds are densified, extruded, devolatilized, and pelletized to produce the purer plastic. The % improvement of the dE for the purer plastic compared to the first plastic >25% relative to the color standard of the base unprinted first plastic.

### IX. Methods

1. Simulated Water Wash Processes→Water wash processes for recycled plastics are well known and operate at tremendous commercial scale across the globe. Considering the size and scale of these commercial operations, it is challenging to evaluate the relative cleaning efficiencies of these processes. In addition, it is challenging to produce small-scale samples of recycled materials produced by these known processes. As such, the Association of Plastics Recyclers has developed a “Simulated” Water Wash Process that attempts to replicate the performance of commercial plastics washing operations at the small scale to provide representative small-scale samples (Polyolefin Standard Laboratory Processing Practises, Document Number 0-P00, Date Jul. 24, 2020, pg. 11). The “Simulated Caustic” process is designed to replicate the performance of a typical water washing process including caustic. The “Simulated Non-Caustic” process is designed to replicate the performance of a typical water washing process excluding caustic. The Simulated Water Wash Process methods used herein is a modified version of the APR method. The modifications are shown in Table 2 below:
2. Gloss measurement method→Gloss was measured using a BYK #gloss meter. The meter measured gloss at three different angles including 2, 60, and 90. The 60 degree measurement was used due to less inherent variability due to limited sample cross-sectional area. Plastic samples were selected based upon amendable size for the meter, which were the largest representative sizes within the distribution of the plastic. For example, for most of the examples contained herein, the samples were typically at least ˜20 mm in two directions. In addition, the plastic was sampled such that the base plastic was available on the surface on at least one side of the sample. For example, surface printed films typically have regions that contain no print or one side is printed while the other side is not. The gloss measurements were made on the non-printed side or a non-printed region. Samples were selected that were predominately flat as opposed to samples that contained high amounts of bends or wrinkles to avoid conflict with the gloss measurement. Four samples per test condition and four measurements were made per sample.
3. Sample Preparation Method for Determination of dE >
   a. Compounding of the First or Purer Plastic: The plastic was manually fed into the feed throat of a Pharma 11 mini co-rotating twin screw extruder. The extruder had 7 heating zones with extensive dispersive and distributive mixing elements. The extruder was fitted with a circular strand die. The temperatures of the various zones and die were as follows for the examples of the present in invention: 90, 160, 180, 180, 200, 200, 220, and 220C. Before, between, and after each sample, the compounder was purged with Dowlex 2045G LLDPE until the extrudate was clear. Extrudate from the first or purer plastic was collected and pelletized once consistent material was obtained.
   b. Hot Pressing of Sample Plaques for dE Measurement: A Carver press was used for the production of the plaques. The temperature of the press was set to 180° C. for all examples. A metal “window” frame mold was used to produce the plaques. The window frame was 25 mm×25 mm×1 mm thick. A sheet of Teflon was placed on the bottom platen of the press. The “window” frame mold was placed on the Teflon. Approximately 0.8g of the compounded plastic from step a above was placed on the Teflon sheet within the “window” frame mold. A second sheet of Teflon was placed on top of the sample and “window” frame mold. The upper platen was lowered until in contact with the upper Teflon and allowed to reach steady state temperature over about 5 minutes. After the 5 min, 1.8 mT of pressure was applied by the press for ˜15 sec. The pressure was released and the Teflon, plaque, and mold were removed as one piece from the hot press and placed between two large blocks of aluminum to cool. After cooling, the plaque of the plastic sample was removed.
   c. dE Measurements using L.a.b Values >A Hunterlab Labscan XE instrument was used to quantify color of the various plastic samples using the plaques produced in step b above. The method follows the principals in the ASTM E308. White and black standard tiles were used as backing tiles for opacity readings. A port size of ˜ 12 mm was used with an area of view of ˜12 mm. The mode type was set to reflectance. The light source was D65. The observer angle was set to 10 degrees. The results were reported as X, Y, Z, L*, a*, and b* and Y for opacity. The dE is calculated relative to the color of the first plastic absent surface print or other coatings, which is also known as the color of the base plastic. The base plastic color can be determined by sampling unprinted and uncoated regions of the first plastic.
   For opacified white base first plastics, the dE was calculated relative to a perfectly white sample represented by a Laneta card using the formula:

$$d E = \sqrt{{( {L}_{p}^{*} - {L}_{w}^{*} )}^{2} + {( {a}_{p}^{*} - {a}_{w}^{*} )}^{2} + {( {b}_{p}^{*} - {b}_{w}^{*} )}^{2}}$$

Where subscript p is for the sample plastic and subscript w is for the white Laneta card. The ‘white’ portion of a Leneta card was used as a common background and as the reference point for dE calculations for white base plastics. For reference, the dE value for a white plastic matching the Leneta card would be zero and positive deviations from zero would be indicative of increased discoloration and the presence of surface contamination such as print. For clear base plastics, the dE is calculated relative to a clear reference sample using the formula:

$$d E = \sqrt{{( {L}_{p}^{*} - {L}_{c}^{*} )}^{2} + {( {a}_{p}^{*} - {a}_{c}^{*} )}^{2} + {( {b}_{p}^{*} - {b}_{c}^{*} )}^{2}}$$

Where subscript p is for the sample plastic and subscript c is for the clear reference. The dE value for a clear plastic would be zero and positive deviations from zero would be indicative of increased discoloration and residual surface contamination.

For base plastics of color other than white or clear, a similar calculation methodology should be used. In such cases, the reference should be selected to be similar in color to the underlying base film determined by sampling in regions absent print or coatings. The dE is calculated relative to this similar color using the formula:

$$d E = \sqrt{{( {L}_{p}^{*} - {L}_{d}^{*} )}^{2} + {( {a}_{p}^{*} - {a}_{d}^{*} )}^{2} + {( {b}_{p}^{*} - {b}_{d}^{*} )}^{2}}$$

Where subscript p is for the sample plastic and subscript d is for the color reference.
If the first plastic comprises a mixture of colors for the base plastic, then a standard sample should be produced based upon the approximate distribution of the observed color variance in proportion to the observed colors. Another acceptable alternative is to compare first plastic portions of similar base color to purer plastic portions of the same color followed by mass averaging the individual dEs for the various base colors within the distribution. If the averaging is done based upon first methodology, then the dE values are calculated relative to this reference using the following formula:

$$d E = \sqrt{{( {L}_{p}^{*} - {L}_{e}^{*} )}^{2} + {( {a}_{p}^{*} - {a}_{e}^{*} )}^{2} + {( {b}_{p}^{*} - {b}_{e}^{*} )}^{2}}$$

Where subscript p is for the sample plastic and subscript e is for the approximate color distribution of the base plastic.
d. % Improvement in dE relative to the same standard→The % improvement in dE is a directional measure of the efficacy of surface cleaning and is calculated by the following formula:

$$\% improvement in dE = \frac{( d {E}_{f p} - d {E}_{p p} )}{d {E}_{f p}} \times 100$$

Where subscript dE_{fp} is the dE for the first plastic relative to the appropriate standard, dEₚₚ is the dE for the purer plastic relative to the same standard. A positive percent improvement implies the color of the purer plastic is directionally closer to the standard color than the first plastic, which would be the case for plastics with reduced surface contamination such as reduced amount of surface print.

The foregoing description is given for clearness of understanding only, and no unnecessary limitations should be understood therefrom, as modifications within the scope of the invention may be apparent to those having ordinary skill in the art.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, comprising any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A purification method for producing a purer plastic from a first plastic comprising:
a. obtaining the first plastic, wherein said first plastic has a concentration of surface contaminants;
b. obtaining a purification fluid having particles suspended within the purification fluid;
c. utilizing mutual convection between the first plastic and the purification fluid having suspended particles within to enhance mechanical abrasion of the first plastic;
d. resulting in a purer plastic having a reduced concentration of surface contaminants from the first plastic.

2. The method of claim 1 wherein said first plastic comprises a reclaimed plastic.

3. The method of claim 1 wherein said first plastic is comprised of a surface printed film or sheet.

4. The method of claim 1, wherein there is an improvement in dE between a homogenized sample of the first plastic and a homogenized sample of the purer plastic of at least 10% relative to the same standard.

5. The method of claim 1, wherein there is a reduction in gloss between the first plastic and the purer plastic of at least 25%.

6. The method of claim 1, wherein said purification fluid comprises water and/or an organic solvent.

7. The method of claim 1, further comprising separating the purer plastic from the purification fluid, purifying the purification fluid, and then using at least 50% of the purified purification fluid to repeat steps (c) and (d).

8. The method of claim 1, wherein said mutual convection is either a mechanical stirring device inside a stationary tank or a rotating drum.

9. The method of claim 1, wherein said mutual convection comprises multiple convection stages.

10. The method of claim 1, wherein said particles have a mass average equivalent sphere diameter from about 200 microns to about 25 mm.

11. The method of claim 1, wherein said particles comprise stainless-steel having a Rockwell C hardness of at least about 50.

12. The method of claim 1, wherein said particles comprise ceramic having a Moh's hardness greater than about 8.0.

13. The method of claim 1, wherein said particles comprise polymers having a Moh's hardness greater than the Moh's hardness of the first plastic.

14. The method of claim 13, wherein said polymers comprise a form of the first plastic.

15. The method of claim 1, wherein said particles comprise a recycled material.

16. The method of claim 1, wherein the volume ratio of said particles to said purification fluid is from about 0.01 to about 10.0.

17. The method of claim 1, wherein the volume ratio of said particles to said first plastic is about 0.01 to about 100.

18. The method of claim 1, further comprising separating the particles from the purer plastic and the purification fluid and then using at least 50% of the separated particles to repeat steps (c) and (d).

19. A purification method for producing a purer plastic from a first plastic, comprising:
a. obtaining the first plastic, wherein said first plastic comprises a reclaimed film and has a concentration of surface contaminants;
b. obtaining a purification fluid, wherein said purification fluid comprises water and/or organic solvent, and has inorganic particles suspended within the purification fluid;
c. mutually convecting the first plastic, the purification fluid, and the particles, causing mechanical abrasion of the first plastic;
d. resulting in a purer plastic having a reduced concentration of surface contaminants from the first plastic;
wherein the volume ratio of the inorganic particles to the first plastic is from about 0.01 to about 100;
wherein the volume ratio of the inorganic particles to the purification fluid is from about 0.1 to about 100; and
wherein there is an improvement in dE between a homogenized sample of the first plastic and a homogenized sample of the purer plastic of at least 10% relative to the same standard.

20. The method of claim 19, further comprising separating the inorganic particles from the purer plastic and the purification fluid and then using at least 50% of the separated inorganic particles and at least 50% of the purification fluid to repeat steps (c) and (d).
